(19) United States
(12) Patent Application Publication
(10) Pub. No.: US 2024/0428764 A1
(43) Pub. Date: Dec. 26, 2024

(54) KEYBOARD DEVICE AND METHOD FOR GUIDING KEY

(71) Applicant: Roland Corporation, Shizuoka (JP)

(72) Inventors: Mutsuo Sawada, Shizuoka (JP); Shiro Uno, Shizuoka (JP)

(73) Assignee: Roland Corporation, Shizuoka (JP)

(21) Appl. No.: 18/744,708

(22) Filed: Jun. 17, 2024

(30) Foreign Application Priority Data
Jun. 21, 2023 (JP) 2023-101932

(51) Int. Cl. G10H 1/34

(52) U.S. Cl. CPC G10H 1/346; G10H 2220/221; G10H 2220/265

(57) ABSTRACT

A keyboard device includes: a support member; and keys swingably supported by the support member. One of the support member and the key includes a guide groove guiding swinging of a key rear portion, and the other includes a guide shaft extending in a scale direction, inserted into the guide groove, and sliding along the guide groove when the key swings. The keys comprise white and black keys. When a point where a guide shaft center is positioned in a pre-key-pressed state is a starting point of the guide groove, a point where the guide shaft center is positioned in a state where the key is pressed to an ending edge position is an ending point of the guide groove, and a line connecting the starting and ending points is an angle of the guide groove, the angle of the guide groove differs between the white or black keys.

### CROSS-REFERENCE TO RELATED APPLICATION

This application claims the priority benefit of Japan application serial no. 2023-101932, filed on Jun. 21, 2023. The entirety of the above-mentioned patent application is hereby incorporated by reference herein and made a part of this specification.

### BACKGROUND

### Technical Field

The disclosure relates to a keyboard device and a method for guiding a key and particularly relates to a keyboard device and a method for guiding a key in which increase in size of the keyboard device in a forward-rearward direction can be curbed while displacement trajectories of the keys are changed for each key.

### Description of Related Art

Some acoustic grand pianos (which will hereinafter be referred to as “acoustic pianos”) have a structure in which swinging fulcrums of keys are positioned gradually closer to a player's side throughout the keys from a low tone side to a high tone side. When the swinging fulcrum is at a different position for each key, a displacement trajectory of a key when the key is pressed also changes for each key, so there is a technology of simulating displacement trajectories of respective keys of an acoustic piano on an electronic piano as well.

For example, Patent Document 1 describes a technology in which dimensions of a white key 11w and a black key 11b in a forward-rearward direction are gradually shortened throughout keys from the low tone side to the high tone side. According to this technology, similar to acoustic pianos, the swinging fulcrums of respective keys can be positioned gradually closer to the player's side throughout the keys from the low tone side to the high tone side, and therefore the keys can swing in displacement trajectories similar to those of acoustic pianos. That is, it is possible to give a feeling of playing close to that of acoustic pianos to a player.

### PATENT DOCUMENTS

[Patent Document 1] Japanese Patent Laid-Open No. 2015-034853 (for example, Paragraph 0014, FIG. 1)

However, in the technology in the related art described above, since dimensions of keys in a forward-rearward direction on a low tone side become larger than those on a high tone side, there is a problem that the size of a keyboard device in the forward-rearward direction increases to this extent.

The disclosure provides a keyboard device and a method for guiding a key in which increase in size of the keyboard device in a forward-rearward direction can be curbed while displacement trajectories of the keys are changed for each key.

### SUMMARY

A keyboard device according to the disclosure includes a support member, and keys which are swingably supported by the support member. Either the support member or the key includes a guide groove which guides swinging of a rear portion of the key. The other of the support member and the key includes a guide shaft which extends in a scale direction, is inserted into the guide groove, and slides along the guide groove when the key swings. The keys are include white keys and black keys. When a point where a center of the guide shaft is positioned in a state before the key is pressed is a starting point of the guide groove, a point where the center of the guide shaft is positioned in a state in which the key is pressed to an ending edge position is an ending point of the guide groove, and a straight line connecting the starting point and the ending point is an angle of the guide groove, the angle of the guide groove differs between the white keys or between the black keys.

A method for guiding a key according to the disclosure is a method for guiding the key in a keyboard device including a support member, and keys which are swingably supported by the support member. Either the support member or the key includes a guide groove which guides swinging of a rear portion of the key. The other of the support member and the key includes a guide shaft which extends in a scale direction and is inserted into the guide groove. The keys are include white keys and black keys. When a point where a center of the guide shaft is positioned in a state before the key is pressed is a starting point of the guide groove, a point where the center of the guide shaft is positioned in a state in which the key is pressed to an ending edge position is an ending point of the guide groove, and a straight line connecting the starting point and the ending point is an angle of the guide groove, the angle of the guide groove differs between the white keys or between the black keys. The method for guiding the key includes guiding swinging when the key is pressed through sliding between the guide groove and the guide shaft.

### BRIEF DESCRIPTION OF THE DRAWINGS

FIG. 1 is a perspective view of a keyboard device according to an embodiment.

FIG. 2 is a cross-sectional view of the keyboard device.

FIG. 3 is a cross-sectional view of the keyboard device showing a state in which a white key is pressed to an ending edge position from the state in FIG. 2.

FIG. 4 is a partial enlarged cross-sectional view of the keyboard device along line IV-IV in FIG. 2.

FIG. 5A is a cross-sectional view of a mold showing a situation of molding side plates and a connection plate, and FIG. 5B is a cross-sectional view showing a white key of a first modification example.

FIG. 6A is a cross-sectional view of a white key of a second modification example, FIG. 6B is a cross-sectional view of a mold showing a situation of molding the side plates and the connection plate using the mold, and FIG. 6C is a cross-sectional view of a white key of a third modification example.

FIG. 7A is a perspective view of the white key showing a state in which an attachment member is detached through an attachment hole, and FIG. 7B is a side view of the attachment member.

FIG. 8A is a side view of the white key showing a situation in which the attachment member is inserted into the attachment hole while being elastically deformed, and FIG. 8B is a side view of the white key showing a situation in which the attachment member is inverted about the center thereof and is inserted into the attachment hole.

FIG. 9A is a side view of the white key positioned on the highest tone side, FIG. 9B is a side view of the white key positioned on the lowest tone side, and FIG. 9C is a top view of keys schematically showing positions of virtual axes of the respective white keys.

FIG. 10 is a partial enlarged cross-sectional view of a keyboard device 1 at a position corresponding to the X part in FIG. 2.

FIG. 11A is a top view of the keys schematically showing the positions of the virtual axes according to the first modification example, FIG. 11B is a top view of the keys schematically showing the positions of the virtual axes according to the second modification example, and FIG. 11C is a top view of the keys schematically showing the positions of the virtual axes according to the third modification example.

FIG. 12A is a side view of a white key of a fourth modification example, and FIG. 12B is a perspective view of the white key showing a state in which an attachment member is detached through an attachment hole.

FIG. 13A is a perspective view of a white key of a fifth modification example, and FIG. 13B is a perspective view of the white key showing a state in which an attachment member is detached from a protrusion portion.

### DESCRIPTION OF THE EMBODIMENT

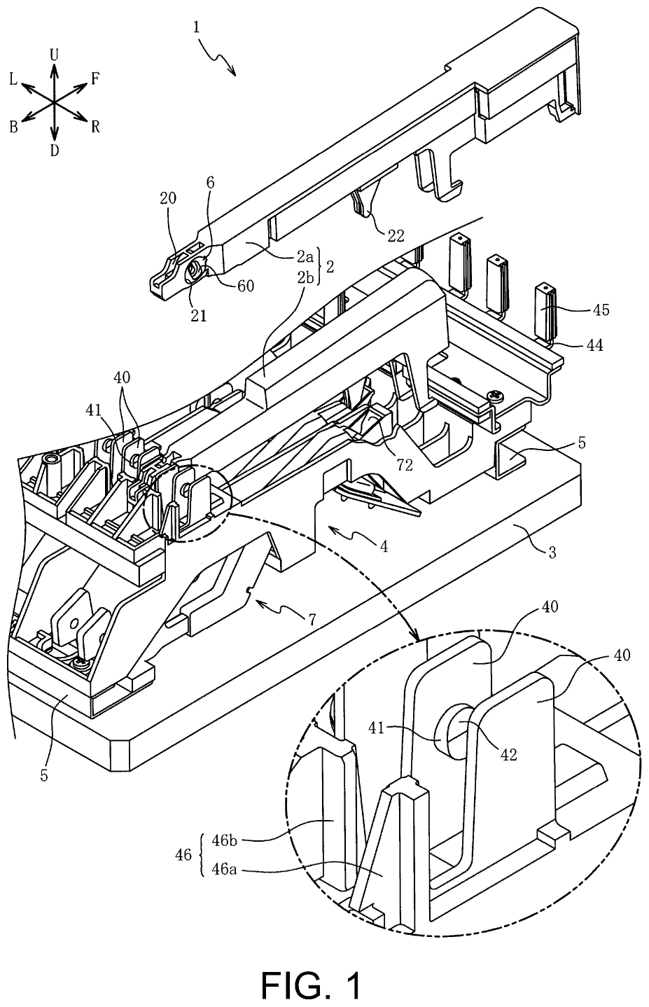

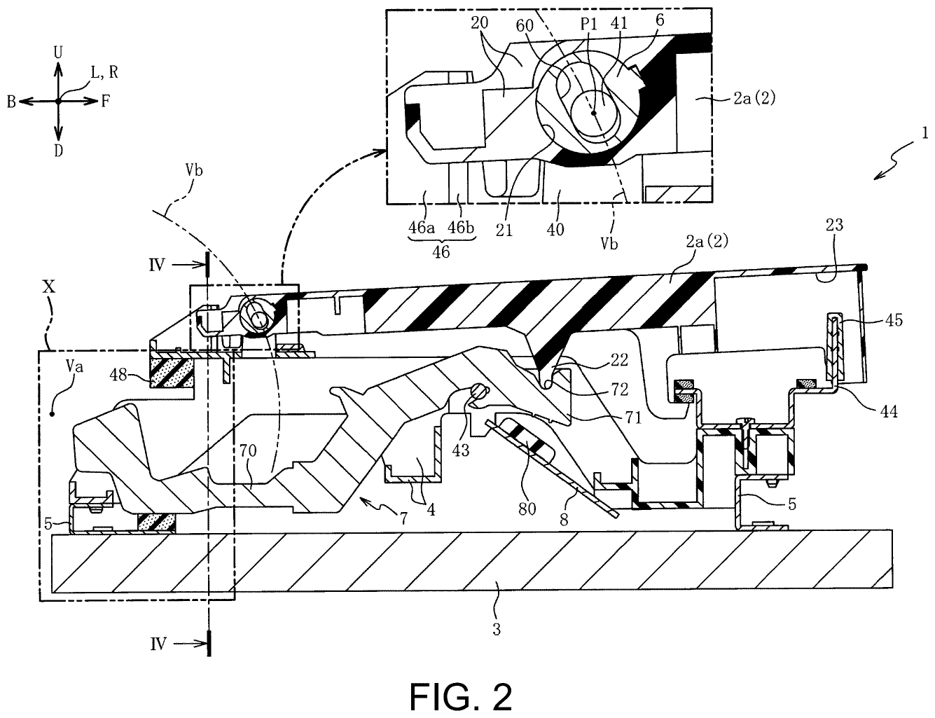

Hereinafter, a preferred embodiment will be described with reference to the accompanying drawings. First, with reference to FIGS. 1 and 2, an overall constitution of a keyboard device 1 will be described. FIG. 1 is a perspective view of the keyboard device 1 according to an embodiment, and FIG. 2 is a cross-sectional view of the keyboard device 1.

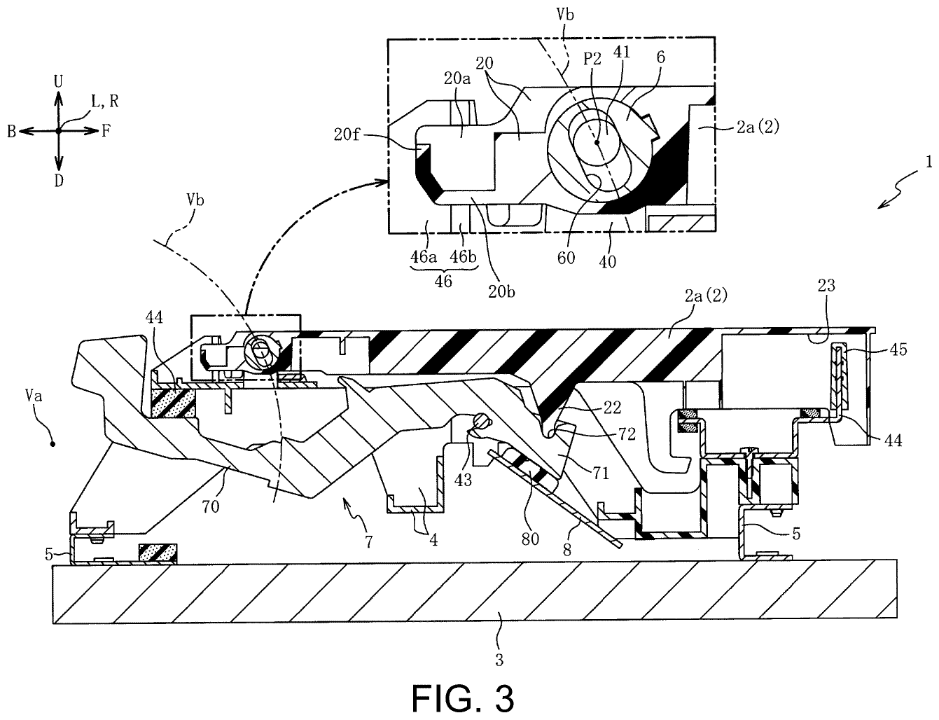

FIG. 1 illustrates a state in which a part of a chassis 4 is cut away and a reception portion 72 of a hammer 7 is exposed, and FIG. 2 illustrates a cross section cut along a flat surface orthogonal to a scale direction (a direction in which a plurality of keys 2 are arranged). In addition, in FIG. 2, in order to facilitate understanding, hatching of shaft portions 41 is omitted. The arrow U-D direction, the F-B direction, and the L-R direction in FIGS. 1 and 2 respectively indicate an upward-downward direction, a forward-rearward direction, and the scale direction of the keyboard device 1, and the same also applies to FIG. 3 and thereafter.

As shown in FIGS. 1 and 2, the keyboard device 1 is a keyboard instrument (electronic piano) including a plurality of (in the present embodiment, 88) keys 2. The keys 2 include a plurality of (in the present embodiment, 52) white keys 2a for playing natural tones and a plurality of (in the present embodiment, 36) black keys 2b for playing derived tones, and the plurality of white keys 2a and the plurality of black keys 2b are arranged in the scale direction (arrow L-R direction).

The keyboard device 1 includes a shelf board 3 for supporting the white keys 2a and the black keys 2b. The shelf board 3 is formed to have a flat plate shape using a synthetic resin, a steel plate, or the like extending in the scale direction, and the resin chassis 4 is supported on an upper surface of this shelf board 3. In the chassis 4, both front and rear end portions thereof (arrow F-B direction) are fixed to the shelf board 3 with a channel material 5 therebetween. Hereinafter, a support structure for the white keys 2a with respect to the chassis 4 and a detailed constitution of the white key 2a will be described. However, the constitution is practically the same in the black key 2b as well.

Wall portions 40 rise upward from an upper surface of the chassis 4 on a rear end side (arrow B side), and the substantially columnar shaft portions 41 protrude in the scale direction from side surfaces of the wall portions 40 on an upper end side (refer to the enlarged part in FIG. 1). The wall portions 40 and the shaft portions 41 are formed integrally with the chassis 4 but may be formed separately from the chassis 4.

A plurality of wall portions 40 are arranged in the scale direction (refer to FIG. 1), and a protrusion portion 20 of the white key 2a is inserted between the plurality of wall portions 40 facing each other. In the following description, a pair of wall portions 40 (shaft portions 41) facing each other with the protrusion portion 20 sandwiched therebetween will be simply described as “a pair of wall portions 40 (shaft portions 41)” or the like.

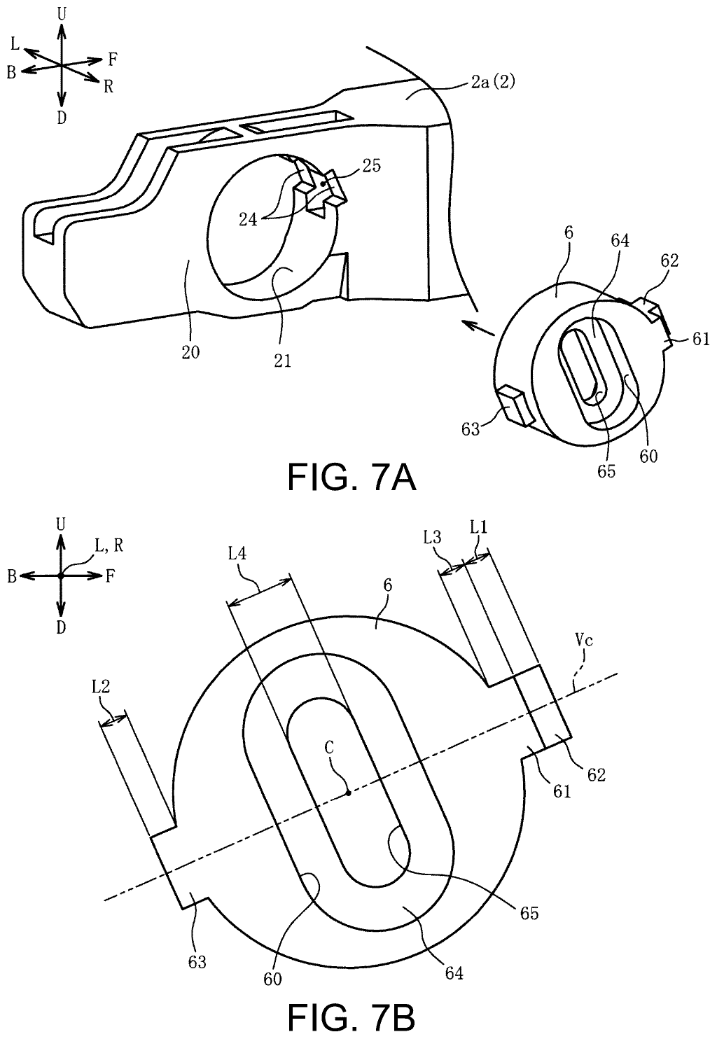

The protrusion portion 20 is a part protruding to the rear side from a rear end portion of the white key 2a, and the protrusion portion 20 is formed to have a smaller dimension in the scale direction than a part of the white key 2a on a front end side (arrow F side) (a part to be pressed). An attachment member 6 having guide grooves 60 is attached to the protrusion portion 20. The attachment member 6 is a component fitted into an attachment hole 21 formed in the protrusion portion 20 (refer to FIGS. 7A and 7B). A method for attaching the attachment member 6 to this white key 2a (protrusion portion 20) will be described below.

The guide grooves 60 are formed on the respective side surfaces of the attachment member 6 on both sides in the scale direction, and the shaft portions 41 formed in the pair of wall portions 40 are fitted into the guide grooves 60. When the shaft portions 41 are fitted into the guide grooves 60, the protrusion portion 20 of the white key 2a is inserted between the pair of shaft portions 41 from above.

In the shaft portion 41, an inclined surface 42 is formed to be inclined such that an upper end of a tip surface thereof is obliquely cutoff (refer to the enlarged part in FIG. 1). When the protrusion portion 20 of the white key 2a is inserted between the pair of shaft portions 41 facing each other from above, the protrusion portion 20 slides along the inclined surfaces 42 of the shaft portions 41. Since the plate-shaped wall portions 40 are elastically deformed and a spacing between the pair of shaft portions 41 facing each other widens due to this sliding, the shaft portions 41 can be easily fitted into the guide grooves 60.

When the shaft portions 41 are fitted into the guide grooves 60, the white key 2a is slidably (swingably) supported between the pair of wall portions 40 facing each other. The hammer 7 interlocked with swinging of the white key 2a is provided below the white key 2a.

A rotation axis 43 lying in the scale direction (refer to FIG. 2) is formed in a substantially central part of the chassis 4 in the forward-rearward direction, and the hammer 7 is rotatably supported by this rotation axis 43. The hammer 7 includes a mass portion 70 (mass body) for giving a feeling of key pressing when the white key 2a is pressed, and the mass portion 70 is positioned on a side behind the rotation axis 43 (arrow B side).

A part of the hammer 7 on a side in front of the rotation axis 43 (arrow F side) is provided as a pressurization portion 71 for pressing a switch 80 of a substrate 8 when the white key 2a is pressed. The reception portion 72, which is recessed downward, is formed on an upper surface of the pressurization portion 71, and a projection portion 22, which is inserted into this reception portion 72, protrudes downward from a lower surface of the white key 2a.

Since the projection portion 22 is simply inserted into (placed on) the reception portion 72, when the white key 2a is assembled, the projection portion 22 is placed on the reception portion 72. Thereafter, as described above, it is sufficient to insert the protrusion portion 20 between the wall portions 40 facing each other and fit the shaft portions 41 into the guide grooves 60. Thus, assembly work of the white key 2a with respect to the chassis 4 can be easily performed.

Meanwhile, when the white key 2a is detached from the chassis 4, the wall portions 40 are elastically deformed (the wall portions 40 open wide) and the shaft portions 41 are removed from the guide grooves 60. Thereafter, it is sufficient to pull out the projection portion 22 from the reception portion 72. Thus, work of detaching the white key 2a can also be easily performed, and therefore maintainability of the white key 2a can be improved.

A lower surface of the projection portion 22 of the white key 2a is formed to have an arc shape projecting downward, and a bottom surface of the reception portion 72 of the hammer 7 is also similarly formed to have an arc shape projecting downward. Contact parts on the lower surface of the projection portion 22 and the bottom surface of the reception portion 72 have the same curvature, and the lower surface of the projection portion 22 and the bottom surface of the reception portion 72 come into surface contact with each other in an initial state (the state in FIG. 2) before the white key 2a is pressed (which will hereinafter be referred to as “an initial position before key pressing” or the like).

Next, with reference to FIGS. 2 and 3, operation when the white key 2a is pressed will be described. FIG. 3 is a cross-sectional view of the keyboard device 1 showing a state in which the white key 2a is pressed to an ending edge position from the state in FIG. 2.

As shown in FIGS. 2 and 3, when the white key 2a is pressed from the initial position, while the lower surface of the projection portion 22 slides along the bottom surface of the reception portion 72, the pressurization portion 71 (reception portion 72) is pressed downward by the projection portion 22. Accordingly, the hammer 7 rotates around (clockwise in FIGS. 2 and 3) the rotation axis 43 (refer to FIG. 3).

The switch 80 is provided below the pressurization portion 71 of the hammer 7, and the switch 80 is pressed by the pressurization portion 71 in response to rotation of the hammer 7 when the white key 2a is pressed. Key pressing information (note information) of the white key 2a is detected by turning on and off this switch 80, and a musical tone signal based on this detection result is output to the outside.

In this manner, swinging of a part of the white key 2a on the front end side at the time of key pressing is guided by rotation of the hammer 7 around the rotation axis 43. Meanwhile, swinging of a part of the white key 2a on the rear end side (a rear portion of the white key 2a on a side behind the center in the forward-rearward direction) is guided by sliding in the guide grooves 60 along the shaft portions 41 of the chassis 4.

At the time of such vertical swinging of the white key 2a, since unstable movement may occur in the white key 2a, such as rotation of the white key 2a around an axis in the forward-rearward direction (so-called rolling), the chassis 4 is provided with a front guide 44 for making swinging of the white key 2a stable.

The front guide 44 is a plate-shaped metal fitting attached to the chassis 4. The front guide 44 rises upward from a front end portion of the chassis 4, and the front guide 44 is inserted into a recessed portion 23 formed on a lower surface of a front end portion of the white key 2a. A rubber cover 45 is mounted in the front guide 44, and when an inner surface of the recessed portion 23 (a surface facing the inward side in the scale direction) comes into contact with the cover 45, swinging of the front end portion of the white key 2a is guided.

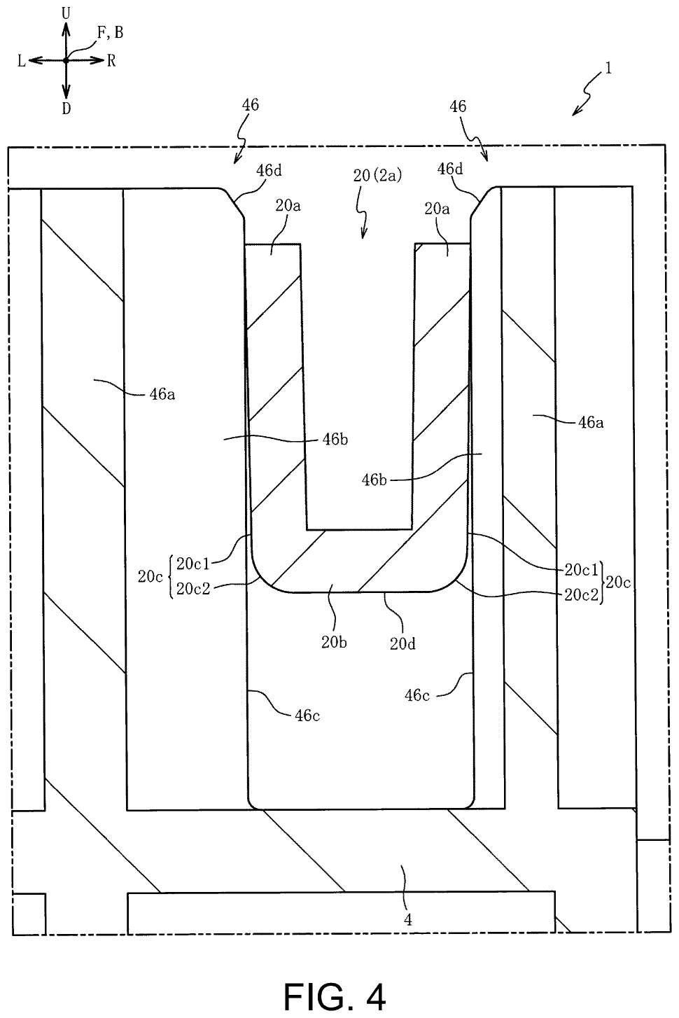

The front guide 44 (cover 45) guides swinging of the white key 2a on a side in front of an engagement position between the white key 2a and the hammer 7, but swinging of a part of the white key 2a on the rear end side is guided by rear guides 46 (refer to the enlarged part in FIGS. 2 and 3). The rear guides 46 respectively include wall portions 46a which are formed on a side behind the shaft portions 41 of the chassis 4, and guide projecting portions 46b which protrude from side surfaces of the wall portions 46a. Vertical swinging of the white key 2a (protrusion portion 20) is guided by these guide projecting portions 46b. A detailed constitution of these rear guides 46 will be described with reference to FIG. 4. FIG. 4 is a partial enlarged cross-sectional view of the keyboard device 1 along line IV-IV in FIG. 2. FIG. 4 illustrates an end surface of the white key 2a (only a cross-sectional shape).

As shown in FIG. 4, the wall portions 46a of the rear guides 46 are each formed to have a wall shape rising upward from the chassis 4, and the guide projecting portions 46b protrude in the scale direction from these wall portions 46a. The wall portions 46a and the guide projecting portions 46b are formed integrally with the chassis 4 but may be formed separately from the chassis 4.

A plurality of wall portions 46a are arranged in the scale direction (arrow L-R direction), and the protrusion portion 20 of the white key 2a is sandwiched between a pair of guide projecting portions 46b provided between the plurality of wall portions 46a facing each other. In the following description, the pair of wall portions 46a (guide projecting portions 46b) facing each other with the protrusion portion 20 sandwiched therebetween will be simply described as “a pair of wall portions 46a (guide projecting portions 46b)” or the like.

The protrusion portion 20 is formed to have a box shape including a pair of side plates 20a facing each other in the scale direction, and a connection plate 20b connecting lower end portions of the pair of side plates 20a to each other in the scale direction. Tip surfaces of the guide projecting portions 46b (surfaces facing the side plates 20a side) serve as guide surfaces 46c guiding vertical swinging of the side plates 20a, and side surfaces of the protrusion portion 20 (outer surfaces of the side plates 20a) respectively facing the guide surfaces 46c in the scale direction serve as guided surfaces 20c.

The guide surfaces 46c are flat surfaces orthogonal to the scale direction, and cutouts 46d, which are inclined upward in directions in which they are separated from each other (protrusion portion 20 side), are respectively formed at upper ends of the pair of guide surfaces 46c. By forming such cutouts 46d, the insertion can be guided by the cutouts 46d when the protrusion portion 20 is inserted between the pair of guide projecting portions 46b facing each other from above.

The guided surfaces 20c of the white key 2a each include an inclined surface 20cl which is inclined such that the spacing with respect to the guide surface 46c gradually widens from the upper end to the lower end side of the side plate 20a, and a curved surface 20c2 which is connected to a lower end of the inclined surface 20cl.

The inclined surface 20cl is a flat surface inclined at an angle of 0.5° or larger and smaller than 1° with respect to the guide surface 46c (vertical direction), and the curved surface 20c2 is an arc-shaped curved surface connecting the lower end of the inclined surface 20cl (the outer surface of the side plate 20a) and a lower surface 20d of the connection plate 20b.

FIG. 4 illustrates the initial state before the white key 2a is pressed. However, when the white key 2a is pressed from this state, the guided surfaces 20c (the inclined surfaces 20cl and the curved surfaces 20c2) slide downward with respect to the guide surfaces 46c, and when the white key 2a is released from the key pressing state, the guided surfaces 20c slide upward with respect to the guide surfaces 46c.

Due to upward sliding of the guided surfaces 20c at the time of this key releasing, grease applied to the guide surfaces 46c and the guided surfaces 20c is scraped upward. However, in the present embodiment, this grease that has been scraped upward is likely to be retained in sliding regions between the guide surfaces 46c and the guided surfaces 20c (which will hereinafter be referred to as “sliding regions on the guided surfaces 20c”).

Specifically, at the initial position before key pressing, the entire guided surfaces 20c (from upper ends of the inclined surfaces 20cl to lower ends of the curved surfaces 20c2) face the guide surfaces 46c in the scale direction. Namely, the guided surfaces 20c (inclined surfaces 20cl) are provided not to protrude to the upward side beyond the guide surfaces 46c when the white key 2a returns to the initial position after having been pressed (the state in FIG. 4).

Accordingly, it is possible to curb a situation in which the grease that has been scraped upward due to swinging of the white key 2a is pushed out to the cutouts 46d or the upper surface sides of the guide projecting portions 46b. Further, since the grease that has been scraped upward flows downward along the guide surfaces 46c due to its own weight, the grease is likely to be retained in the sliding regions on the guided surfaces 20c. Thus, a feeling of pressing the white key 2a can be improved.

In addition, the spacings between the guide surfaces 46c and the guided surfaces 20c (the inclined surfaces 20cl and the curved surfaces 20c2) are formed to gradually widen from the upper end sides to the lower ends of the guided surfaces 20c. Thus, slight gaps are formed between the guide surfaces 46c and the lower end portions of the guided surfaces 20c, and these gaps are formed to gradually increase toward the lower ends of the guided surfaces 20c. Accordingly, it is possible to curb a situation in which the grease is scraped off downward when the guided surfaces 20c slide downward with respect to the guide surfaces 46c. This also makes the grease be likely to be retained in the sliding regions on the guided surfaces 20c, and therefore a feeling of pressing the white key 2a can be improved.

Here, when it is intended to make the grease be unlikely to be scraped off, for example, the curved surfaces 20c2 can be omitted (the inclined surfaces 20cl and the lower surface 20d of the connection plate 20b are extended and connected), and inclination angles of the inclined surfaces 20cl with respect to the guide surfaces 46c can also be formed to be relatively large. However, in the case of such a constitution, since a rattle is more likely to occur in sliding of the guided surfaces 20c with respect to the guide surfaces 46c as the inclination angles of the inclined surfaces 20cl with respect to the guide surfaces 46c increase, swinging of the white key 2a cannot be stably guided. On the other hand, as the inclination angles of the inclined surfaces 20cl become close to parallel to the guide surfaces 46c, the grease is more likely to be scraped off downward when the white key 2a swings.

In contrast, the guided surfaces 20c of the present embodiment each include the inclined surface 20cl which is a flat surface inclined with respect to the guide surface 46c, and the curved surface 20c2 which is connected to the lower end of the inclined surface 20cl. Since the curved surface 20c2 has a larger widening degree of the spacing with respect to the guide surface 46c than the inclined surface 20cl and a relatively wide gap is formed between the curved surface 20c2 and the guide surface 46c, it is possible to effectively curb a situation in which the grease is scraped off due to this gap.

Namely, since a function of curbing scraping off of the grease is mainly imparted to the curved surfaces 20c2, a function of curbing scraping off of the grease can be sufficiently exhibited to that extent while the angles of the inclined surfaces 20cl with respect to the guide surfaces 46c can be set close to parallel as much as possible. Thus, while occurrence of a rattle in sliding of the guided surfaces 20c with respect to the guide surfaces 46c is curbed, it is possible to curb a situation in which the grease is scraped off due to the sliding.

In the present embodiment, the widening degrees of the spacings between the guide surfaces 46c and the lower end portions of the guided surfaces 20c are increased by forming the curved surfaces 20c2 at the lower ends of the inclined surfaces 20cl, but the embodiment is not necessarily limited to this. For example, a constitution in which the curved surfaces 20c2 are inclined surfaces (flat surfaces) inclined with respect to the guide surfaces 46c and inclination angles of the inclined surfaces (angles with respect to the guide surfaces 46c) are larger than those of the inclined surfaces 20cl may be adopted. In this constitution as well, while occurrence of a rattle in sliding of the guided surfaces 20c with respect to the guide surfaces 46c is curbed, it is possible to curb a situation in which the grease is scraped off due to the sliding.

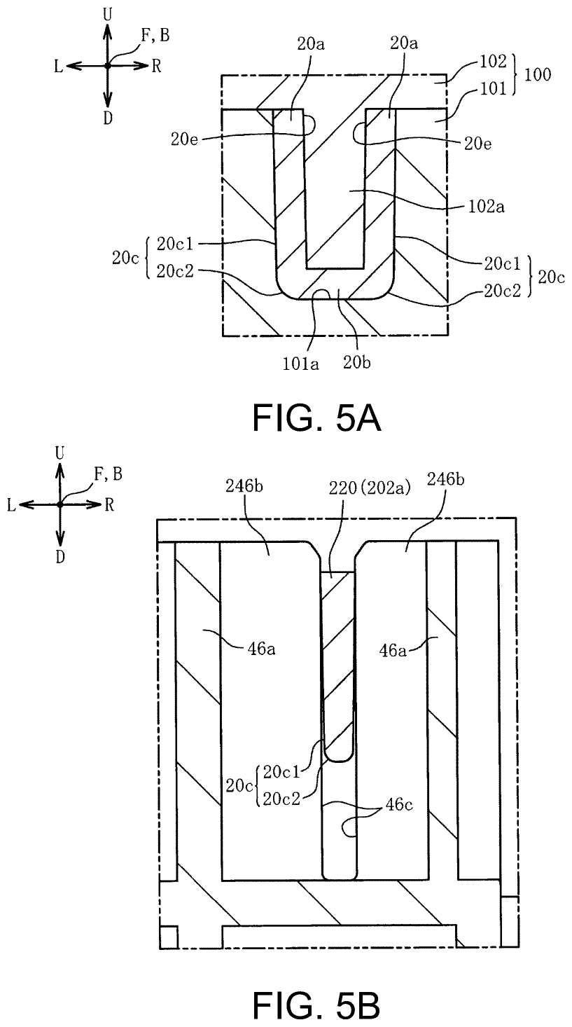

Next, with reference to FIG. 5A, a method for molding the side plates 20a and the connection plate 20b (the protrusion portion 20 of the white key 2a) using a mold 100 will be described. FIG. 5A is a cross-sectional view of the mold 100 showing a situation of molding the side plates 20a and the connection plate 20b.

As shown in FIG. 5A, the mold 100 for molding the side plates 20a and the connection plate 20b includes a lower mold 101 and an upper mold 102. A recessed portion 101a is formed in the lower mold 101, and a projecting portion 102a which is inserted into this recessed portion 101a is formed in the upper mold 102. When the projecting portion 102a is inserted into the recessed portion 101a, a cavity having a shape corresponding to the pair of side plates 20a and the connection plate 20b is formed in the mold 100. After a heated and melted resin material is injected into this cavity through an injection port (not shown), the resin material is cooled (solidified), and the side plates 20a and the connection plate 20b are thereby molded.

The side plates 20a and the connection plate 20b which have been molded are separated from the mold 100. However, as described above, the inclined surfaces 20cl forming the side surfaces of the side plates 20a have an angle of 0.5° or larger and smaller than 1º, and this inclination also functions as a draft for separating the side plates 20a from the recessed portion 101a of the lower mold 101.

In addition, inner surfaces 20e of the side plates 20a facing each other between the pair of side plates 20a are also similarly inclined at an angle parallel to the inclined surfaces 20cl, and this inclination also serves as a draft for separating the side plates 20a from the projecting portion 102a of the upper mold 102.

When the white key 2a is molded using such a resin material, there is a need for each of the portions of the white key 2a to have a plate thickness of 2 to 3 mm in order to prevent deterioration in moldability thereof. In this case, as in a white key 202a of a first modification example shown in FIG. 5B, if a protrusion portion 220 is formed to have a single plate shape, it becomes difficult to ensure the rigidity of the protrusion portion 220. If the protrusion portion 220 has a low rigidity, since the protrusion portion 220 sandwiched between guide projecting portions 46b is likely to be deformed when the white key 202a swings, there may be a problem that swinging of the white key 202a cannot be stably guided or a problem that the protrusion portion 220 is likely to be damaged.

In contrast, the protrusion portion 20 of the present embodiment is formed to have a box shape including the pair of side plates 20a of which outer surfaces directed in the scale direction are formed as the guided surfaces 20c, and the connection plate 20b which connects the pair of side plates 20a to each other in the scale direction. Accordingly, when the white key 2a is molded with a mold using a resin material, that is, even when the thickness of each of the plates 20a and 20b of the protrusion portion 20 is limited 2 to 3 mm, the rigidity of the protrusion portion 20 can be ensured. Swinging of the white key 2a can be stably guided and damage to the protrusion portion 20 can be curbed by ensuring the rigidity of the protrusion portion 20.

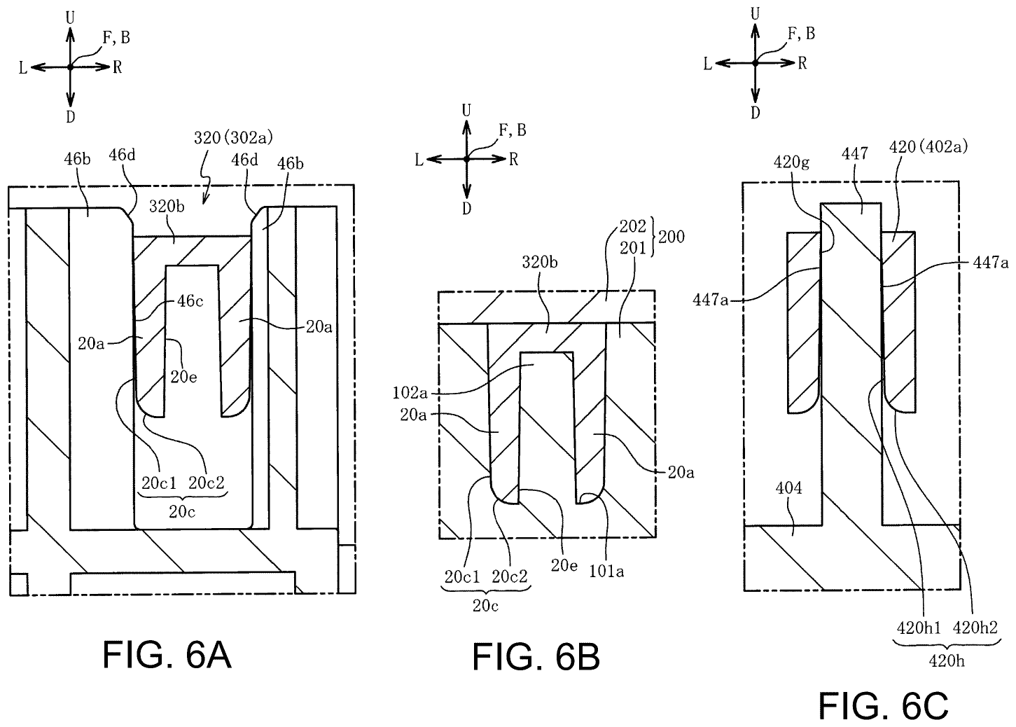

Here, when it is intended to form the protrusion portion 20 of the white key 2a in a box shape, for example, as in a white key 302a of a second modification example shown in FIG. 6A, upper ends of the side plates 20a of a protrusion portion 320 can also be connected to each other by a connection plate 320b. A method for molding such a protrusion portion 320 using a mold 200 will be described below with reference to FIG. 6B. However, if the protrusion portion 320 is provided with a draft for the time of molding using the mold 200, there is a need for the side plates 20a to be formed with a tapered plate thickness. Thus, there is a problem that moldability of the protrusion portion 320 deteriorates or a problem that the rigidity of the protrusion portion 320 is degraded.

In contrast, in the present embodiment, as shown in FIG. 5A, the protrusion portion 20 is formed to have a box shape by connecting the lower ends of the pair of side plates 20a to each other by the connection plate 20b, and the spacing between the inner surfaces 20e of the pair of side plates 20a is formed to gradually narrow toward the lower end sides of the side plates 20a. Accordingly, since the plate thicknesses of the side plates 20a can be made substantially uniform (the inclined surfaces 20cl and the inner surfaces 20e of the side plates 20a can be formed substantially parallel to each other) while drafts with respect to the lower mold 101 and the upper mold 102 are formed on the side plates 20a, moldability of the protrusion portion 20 can be improved. Moreover, since the rigidity of the protrusion portion 20 can be ensured by forming the side plates 20a having a uniform plate thickness, swinging of the white key 2a can be stably guided.

In this manner, in the present embodiment, the rear end side of the protrusion portion 20 is formed to have a box shape by the pair of side plates 20a and the connection plate 20b. However, a rear end side of a space surrounded by each of these plates 20a and 20b is closed by a closing plate 20f (refer to the enlarged part in FIG. 3). A lower end of the closing plate 20f is connected to the connection plate 20b, and both ends of the closing plate 20f in the scale direction (arrow L-R direction in FIG. 3) are connected to the pair of side plates 20a. Since the rigidity of the protrusion portion 20 can be improved by providing such a closing plate 20f, swinging of the white key 2a can be stably guided.

Next, with reference to FIG. 5B, the white key 202a of the first modification example will be described. The same reference signs are applied to parts which are the same as those in the foregoing embodiment, and description thereof will be omitted. FIG. 5B is a cross-sectional view of the white key 202a of the first modification example. FIG. 5B illustrates a cross section of the keyboard device 1 (refer to FIG. 2) cut at a position corresponding to that in FIG. 4.

As shown in FIG. 5B, in the white key 202a of the first modification example, the protrusion portion 220 is formed to have a single plate shape, and the guided surfaces 20c (the inclined surfaces 20cl and the curved surfaces 20c2) described in the foregoing embodiment are formed on the side surfaces of the plate-shaped protrusion portion 220.

The pair of guide projecting portions 246b sandwiching this protrusion portion 220 therebetween from both sides in the scale direction have the same constitution as those of the guide projecting portions 46b (refer to FIG. 4) described in the foregoing embodiment except that protrusion lengths from the wall portions 46a are lengthened. Namely, the guide surfaces 46c similar to those in the foregoing embodiment are formed on tip surfaces of the guide projecting portions 246b.

In this white key 202a of the first modification example as well, at the initial position before key pressing, the entire guided surfaces 20c (the inclined surfaces 20cl and the curved surfaces 20c2) face the guide surfaces 46c. Accordingly, when the pressed white key 202a returns to the initial position (the state in FIG. 5B), it is possible to curb a situation in which the grease that has been scraped up by the white key 202a is pushed out to the cutouts 46d or the upper surface sides of the guide projecting portions 246b. Thus, the grease is likely to be retained in the sliding regions on the guided surfaces 20c.

In addition, since the spacings between the guide surfaces 46c and the guided surfaces 20c (the inclined surfaces 20cl and the curved surfaces 20c2) gradually widen from the upper end sides to the lower ends of the guided surfaces 20c, even if the guided surfaces 20c slide downward with respect to the guide surfaces 46c when the white key 202a is pressed, the grease applied to each of these surfaces 20c and 46c is unlikely to be scraped off downward. This also makes the grease be likely to be retained in the sliding regions on the guided surfaces 20c.

Next, with reference to FIGS. 6A and 6B, the white key 302a of the second modification example will be described. FIG. 6A is a cross-sectional view of the white key 302a of the second modification example, and FIG. 6B is a cross-sectional view of the mold 200 showing a situation of molding the side plates 20a and the connection plate 320b using the mold 200. FIG. 6A illustrates a cross section of the keyboard device 1 (refer to FIG. 2) cut at a position corresponding to that in FIG. 4.

The white key 302a of the second modification example has the same constitution as the white key 2a (refer to FIG. 4) described in the foregoing embodiment except that the connection plate 320b of the protrusion portion 320 connects the upper ends of the side plates 20a to each other in the scale direction.

That is, the protrusion portion 320 is formed to have a box shape having an opening on the lower surface side, and the guided surfaces 20c are formed on the side surfaces of this box-shaped protrusion portion 320 (side plates 20a). End portions of the curved surfaces 20c2 of the guided surfaces 20c on the inward sides in the scale direction are connected to the lower ends on the inner surfaces 20e of the side plates 20a.

In this white key 302a of the second modification example as well, at the initial position before key pressing, the entire guided surfaces 20c (the inclined surfaces 20cl and the curved surfaces 20c2) face the guide surfaces 46c. Accordingly, when the pressed white key 302a returns to the initial position (the state in FIG. 6A), it is possible to curb a situation in which the grease that has been scraped up by the white key 302a is pushed out to the cutouts 46d or the upper surface sides of the guide projecting portions 46b. Thus, the grease is likely to be retained in the sliding regions on the guided surfaces 20c.

In addition, since the spacings between the guide surfaces 46c and the guided surfaces 20c (the inclined surfaces 20cl and the curved surfaces 20c2) gradually widen from the upper end sides to the lower ends of the guided surfaces 20c, even if the guided surfaces 20c slide downward with respect to the guide surfaces 46c when the white key 302a is pressed, the grease applied to each of these surfaces 20c and 46c is unlikely to be scraped off downward. This also makes the grease be likely to be retained in the sliding regions on the guided surfaces 20c.

As shown in FIG. 6B, in the mold 200 for molding the side plates 20a and the connection plate 320b, the projecting portion 102a (refer to FIG. 5A) described in the foregoing embodiment is omitted from an upper mold 202, and the projecting portion 102a is formed on a bottom surface of the recessed portion 101a of a lower mold 201 (in a manner of being vertically inverted).

When such a projecting portion 102a is formed in the lower mold 201, in order to form drafts with respect to the lower mold 201 on the side plates 20a, there is a need for the inner surfaces 20c of the side plates 20a to be inclined in a direction in which they approach the inclined surfaces 20cl from the upper ends to the lower ends thereof. Namely, the lower end sides of the side plates 20a have a tapered shape. Thus, when it is desired to further ensure the rigidity of the protrusion portion 320 or when it is desired to improve the moldability of the protrusion portion 320, as in the foregoing embodiment (refer to FIG. 5A), it is preferable to connect the lower ends of the side plates 20a to each other by the connection plate 20b.

Next, with reference to FIG. 6C, a white key 402a of a third modification example will be described. FIG. 6C is a cross-sectional view of the white key 402a of the third modification example. FIG. 6C illustrates a cross section of the keyboard device 1 (refer to FIG. 2) cut at a position corresponding to that in FIG. 4.

As shown in FIG. 6C, in the white key 402a of the third modification example, a vertically extending insertion hole 420g is formed in a protrusion portion 420, and a pillar-shaped rear guide 447 rising upward from the chassis 4 is inserted into this insertion hole 420g.

Guide surfaces 447a facing both sides of the rear guide 447 in the scale direction are flat surfaces orthogonal to the scale direction. A pair of inner surfaces facing the inward sides of the insertion hole 420g in the scale direction are guided surfaces 420h respectively facing the guide surfaces 447a.

The guided surfaces 420h each include an inclined surface 420h1 which is inclined such that the spacing with respect to the guide surface 447a gradually widens from the upper end thereof to the lower end side, and a curved surface 420h2 which is connected to the lower end of the inclined surface 420h1.

The inclined surface 420h1 is a flat surface inclined at an angle of 0.5° or larger and smaller than 1° with respect to the guide surface 447a (vertical direction), and the curved surface 420h2 is an arc-shaped curved surface connecting the lower end of the inclined surface 420h1 and the side surface of the protrusion portion 420.

In this white key 402a of the third modification example as well, at the initial position before key pressing, the entire guided surfaces 420h (the inclined surfaces 420h 1 and the curved surfaces 420h2) face the guide surfaces 447a. Accordingly, when the pressed white key 402a returns to the initial position (the state in FIG. 6C), it is possible to curb a situation in which the grease that has been scraped up by the protrusion portion 420 is pushed out to the upper surface side of the rear guide 447. Thus, the grease is likely to be retained in the sliding regions on the guided surfaces 420h.

In addition, the spacings between the guide surfaces 447a and the guided surfaces 420h (the inclined surfaces 420h1 and the curved surfaces 420h2) are formed to gradually widen from the upper end sides to the lower ends of the guided surfaces 420h. Thus, slight gaps are formed between the guide surfaces 447a and the lower end portions of the guided surfaces 420h, and these gaps are formed to gradually increase toward the lower ends of the guided surfaces 420h. Accordingly, even if the guided surfaces 420h slide downward with respect to the guide surfaces 447a when the white key 402a is pressed, the grease applied to each of these surfaces 420h and 447a is unlikely to be scraped off downward. This also makes the grease be likely to be retained in the sliding regions on the guided surfaces 420h.

Description will return to FIGS. 2 and 3. As described above, swinging of the rear end portion of the white key 2a is guided by sliding in the guide grooves 60 along the shaft portions 41 of the chassis 4. The attachment member 6 having these guide grooves 60 formed therein is formed using a resin material (for example, an elastomer or rubber) having flexibility. That is, since the attachment member 6 is formed using a soft material having a lower hardness than a resin (for example, an ABS resin) which will become a material of the white key 2a and the chassis 4, for example, compared to when the attachment member 6 is formed using a material which is the same as that (relatively hard) of the white key 2a and the chassis 4, it is possible to curb occurrence of noise at the time of sliding in the guide grooves 60 along the shaft portions 41 of the chassis 4. Thus, it is possible to give a favorable feeling of playing to a player.

Here, at the initial position before key pressing, a point where the centers of the shaft portions 41 are positioned will be described as a starting point P1 of the guide grooves 60 (refer to the enlarged part in FIG. 2), and at the ending edge position of key pressing, a point where the centers of the shaft portions 41 are positioned will be described as an ending point P2 of the guide grooves 60 (refer to the enlarged part in FIG. 3).

The guide grooves 60 extend in a linear shape in a manner of being inclined downward to a front lower side in a side view, and the starting point P1 is positioned on a lower side in front of the ending point P2. In addition, both the starting point P1 and the ending point P2 of the guide grooves 60 are positioned on a virtual circle Vb about a virtual rotation axis of the white key 2a (which will hereinafter be referred to as “a virtual axis Va”).

The virtual axis Va is a point positioned on a lower side behind the shaft portions 41 in a side view and is a point indicating the same position as a swinging fulcrum (rotation axis) of a key of an acoustic piano. Thus, when the white key 2a is pressed, the white key 2a can swing in a displacement trajectory close to that of a key of an acoustic piano due to sliding in the guide grooves 60 along the shaft portions 41. Therefore, it is possible to give a feeling of playing close to that of an acoustic piano to a player.

In a state in which the shaft portions 41 are positioned at the starting point P1 of the guide grooves 60 (refer to the enlarged part in FIG. 2), gaps are formed between the shaft portions 41 and inner circumferential surfaces of the guide grooves 60 on a starting edge (lower end) side. Meanwhile, similarly, in a state in which the shaft portions 41 are positioned at the ending point P2 of the guide grooves 60 (refer to the enlarged part in FIG. 3), gaps are formed between the shaft portions 41 and the inner circumferential surfaces of the guide grooves 60 on an ending edge (upper end) side.

Namely, when regions in which the shaft portions 41 slide from the starting point P1 to the ending point P2 on the inner circumferential surfaces of the guide grooves 60 are sliding surfaces of the guide grooves 60, outer circumferential surfaces of the shaft portions 41 come into contact with only the sliding surfaces of the guide grooves 60 respectively at the initial position before key pressing and the ending edge position of key pressing. Accordingly, when the white key 2a is pressed to the ending edge position or when the white key 2a returns to the initial position from the ending edge position, it is possible to curb a situation in which the shaft portions 41 come into contact (collide) with the inner circumferential surfaces of the guide grooves 60 on the starting edge side or the ending edge side. Thus, since noise caused by the contact can also be curbed, it is possible to give a favorable feeling of playing to a player.

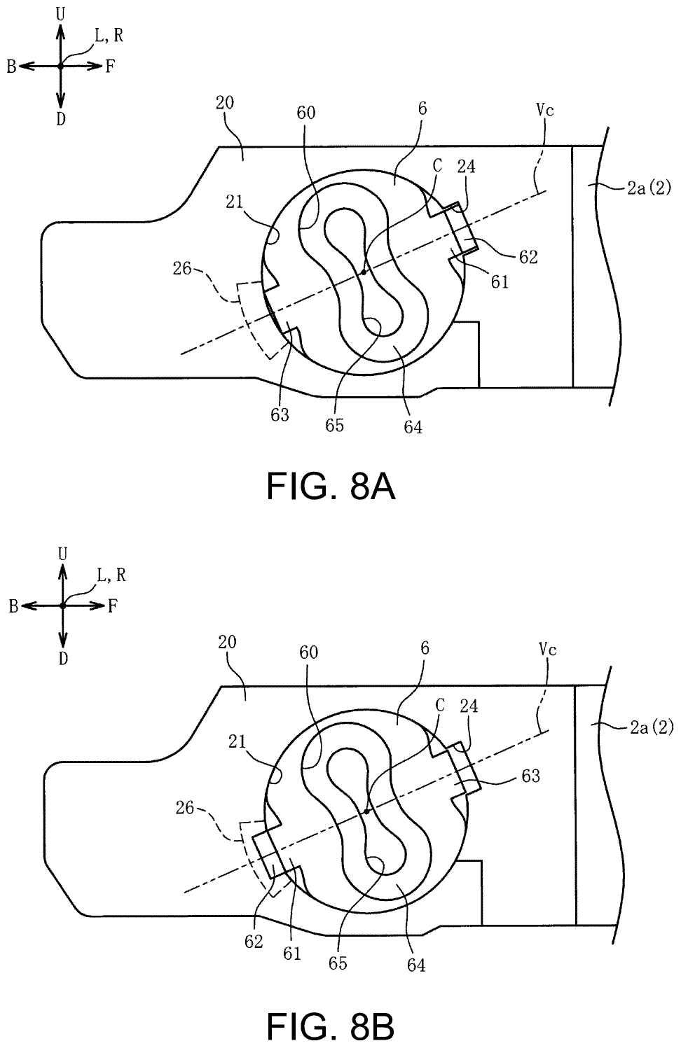

Next, with reference to FIGS. 7 and 8, a detailed constitution of the attachment member 6 will be described. FIG. 7A is a perspective view of the white key 2a showing a state in which the attachment member 6 is detached from the attachment hole 21, and FIG. 7B is a side view of the attachment member 6. FIG. 8A is a side view of the white key 2a showing a situation in which the attachment member 6 is inserted into the attachment hole 21 while being elastically deformed, and FIG. 8B is a side view of the white key 2a showing a situation in which the attachment member 6 is inverted around a center C thereof and is inserted into the attachment hole 21.

As shown in FIGS. 7A and 7B, the attachment hole 21 having a circular cross section for fitting the attachment member 6 is formed in the protrusion portion 20 of the white key 2a, and the attachment member 6 is formed to have a columnar external shape (a shape corresponding to the attachment hole 21) with a center axis in the scale direction. In the following description, a direction around the outer circumferential surface of the attachment member 6 and a direction around the inner circumferential surface of the attachment hole 21 will be described as a circumferential direction.

First projections 61 and second projections 62 and 63 each having a rectangular parallelepiped shape are integrally formed on the outer circumferential surface of the attachment member 6. The first projections 61 are projection for restricting rotation of the attachment member 6 with respect to the attachment hole 21, and the second projections 62 and 63 are projections for restricting falling off of the attachment member 6 from the attachment hole 21.

The first projections 61 are formed at one location in the circumferential direction of the attachment member 6, and the second projections 62 and 63 are formed at two locations in the circumferential direction of the attachment member 6. One second projection 62 of the pair of second projections 62 and 63 protrudes from a central part on the outer circumferential surface (tip surface) of the first projections 61 in the scale direction, and the other second projection 63 protrudes in a direction opposite to the second projection 62 (first projections 61) from a central part on the outer circumferential surface of the attachment member 6 in the scale direction.

The first projections 61 extend in the scale direction in a manner of respectively leading to the pair of side surfaces of the attachment member 6. Meanwhile, the second projections 62 and 63 are formed to have a smaller dimension in the scale direction than the first projections 61 (attachment member 6).

On the inner circumferential surface of the attachment hole 21, fitting holes 24 are formed at positions corresponding to the first projections 61, and fitting holes 25 and 26 are formed at positions corresponding to the second projections 62 and 63 (refer to FIG. 8 for the fitting hole 26).

A pair of fitting holes 24 are formed with the fitting hole 25, into which the second projection 62 is inserted, sandwiched therebetween (side by side in the scale direction), and this pair of fitting holes 24 lead to the side surfaces of the protrusion portion 20 of the white key 2a (exposed to the side surfaces of the protrusion portion 20). Since the inner diameter of the attachment hole 21 of the white key 2a is formed to be slightly larger than the outer diameter of the attachment member 6 (the diameter in a region where the projections 61 to 63 are not formed), for example, if the attachment member 6 has a shape with no second projections 62 and 63, the attachment member 6 can be inserted into the attachment hole 21 (the first projections 61 can be inserted into the fitting holes 24) without having the attachment member 6 elastically deformed.

Meanwhile, in the present embodiment, since the second projections 62 and 63 are formed in the attachment member 6, when the attachment member 6 is intended to be inserted into the attachment hole 21 without being elastically deformed, the second projections 62 and 63 will be caught on the side surfaces of the white key 2a (protrusion portion 20).

Thus, when the projections 61 to 63 of the attachment member 6 are respectively fitted into the fitting holes 24 to 26 of the attachment hole 21, as shown in FIG. 8A, the attachment member 6 is inserted into the attachment hole 21 while being elastically deformed (compressed) such that the region having the second projections 62 and 63 formed therein is recessed as much as at least a total protrusion dimension L1+L2 (refer to FIG. 7B) of the second projections 62 and 63. Further, when the attachment member 6 is inserted to a position where the second projections 62 and 63 reach the fitting holes 25 and 26, the elastically deformed shape of the attachment member 6 is restored, and therefore the projections 61 to 63 are respectively fitted into the fitting holes 24 to 26. Accordingly, attachment of the attachment member 6 to the attachment hole 21 is completed.

The dimensions of the fitting holes 24 in the circumferential direction of the attachment hole 21 are formed to be the same as (or slightly larger than) the dimensions of the first projections 61 in the same direction. Meanwhile, the dimensions of the fitting holes 25 and 26 in the circumferential direction of the attachment hole 21 are formed to be larger than those of the second projections 62 and 63 in the same direction. Thus, when the attachment member 6 is inserted into the attachment hole 21 while being elastically deformed, the second projections 62 and 63 can be fitted into the fitting holes 25 and 26 even in a state in which the relative positions of the fitting holes 24 and the first projections 61 in the circumferential direction are shifted to some extent.

If the attachment member 6 is restored to the original shape in a state in which the relative positions of the fitting holes 24 and the first projections 61 are shifted, although the first projections 61 are in a state of being pressurized by (caught on) the inner circumferential surface of the attachment hole 21, the attachment member 6 is rotated around the center C thereof until the relative positions of the fitting holes 24 and the first projections 61 coincide with each other, and therefore the first projections 61 can be fitted into the fitting holes 24 due to a restoring force of the attachment member 6. Thus, for example, compared to when the dimensions of the fitting holes 25 and 26 and the second projections 62 and 63 in the circumferential direction coincide with each other, since the projections 61 to 63 can be easily fitted into the fitting holes 24 to 26 respectively, workability of attachment work of the attachment member 6 can be improved.

In this manner, the present embodiment has a structure in which the attachment member 6 having the guide grooves 60 formed on the side surfaces is attached to the white key 2a (protrusion portion 20). Accordingly, for example, since the mold for molding the white key 2a can be simplified compared to a constitution in which the guide grooves 60 having flexibility are formed integrally with the white key 2a by two-color molding, manufacturing costs of the white key 2a can be reduced.

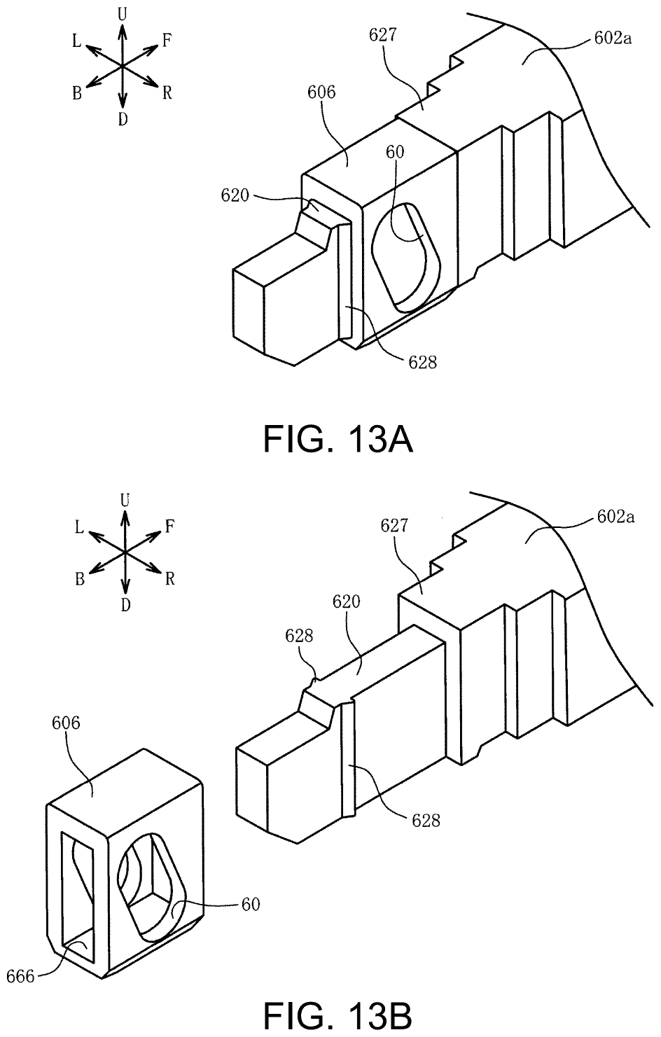

In addition, when the attachment member 6 having the guide grooves 60 is formed separately from the white key 2a, for example, as in a white key 602a of a fifth modification example (refer to FIG. 13) which will be described below, it is also possible to employ a constitution in which an attachment member 606 formed to have an annular shape is fitted into a protrusion portion 620 of the white key 602a. In the case of such a constitution, although details will be described below, there is a need for the attachment member 606 to be pressed to the protrusion portion 620 side over projection-shaped second restriction portions 628, and this pressing relatively requires a force. Since the attachment member 606 is a small-sized component which is handled by a worker with finger tips, in a structure in which the annular attachment member 606 is attached by being pressed to the protrusion portion 620 side, attachment work thereof requires time and effort.

In contrast, as shown in FIGS. 7A and 7B, the present embodiment has a structure in which the attachment hole 21 provided to allow the attachment member 6 to be inserted thereinto is formed in the white key 2a and the attachment member 6 is fitted into this attachment hole 21. When this fitting is performed, although there is a need for the attachment member 6 to be elastically deformed as shown in FIG. 8A, this clastic deformation can be relatively casily performed by a worker compressing the attachment member 6 while grasping it with finger tips. Thus, workability of attachment work of the attachment member 6 with respect to the attachment hole 21 can be improved.

In addition, the present embodiment has a structure in which the attachment member 6 is attached to the white key 2a. However, for example, it is also possible to employ a constitution in which attachment holes for attaching the attachment member 6 are formed in the wall portions of the chassis 4 (refer to FIG. 1) and a guide shaft (a part corresponding to the shaft portions 41) which can be inserted into the guide grooves 60 of the attachment member 6 is provided in the protrusion portion 20 of the white key 2a. However, since a plurality of wall portions 40 of the chassis 4 are integrally formed side by side in the scale direction, in a structure in which the attachment member 6 is attached to each of the wall portions 40, attachment work thereof requires time and effort.

In contrast, the present embodiment has a constitution in which the attachment hole 21 for attaching the attachment member 6 is formed in the white key 2a, and each of the white keys 2a arranged in the scale direction can be detached from the chassis 4. Thus, since work of attaching the attachment member 6 to the attachment hole 21 can be individually performed for each of the white keys 2a in a state in which the white key 2a has been detached from the chassis 4, workability of attachment work of the attachment member 6 can be improved.

In a state in which the attachment member 6 is attached to the attachment hole 21, change in attachment angle of the attachment member 6 in the circumferential direction of the attachment hole 21 is restricted due to the first projections 61 caught by the fitting holes 24. In addition, falling off of the attachment member 6 from the attachment hole 21 is restricted due to the second projections 62 and 63 caught by the fitting holes 25 and 26.

Regarding another constitution for restricting such change in attachment angle or falling off of the attachment member 6, a constitution in which each of the projections 61 to 63 (fitting holes 24 to 26) is omitted and the attachment member 6 is adhered to the attachment hole 21 is described as an example. However, in this constitution, attachment work of the attachment member 6 with respect to each of the white keys 2a requires time and effort.

In contrast, the present embodiment has a constitution in which the first projections 61 and the fitting holes 24 (positioning portions) including unevenness that can be fitted to each other, the second projections 62 and 63, and the fitting holes 25 and 26 (restriction portions) are formed with respect to the inner circumferential surface of the attachment hole 21 and the outer circumferential surface of the attachment member 6. By restricting change in attachment angle or falling off of the attachment member 6 due to fitting of the unevenness, work of adhering the attachment member 6 to each of the white keys 2a can be made unnecessary. Thus, workability of attachment work of the attachment member 6 can be improved.

In addition, regarding another constitution for restricting change in attachment angle or falling off of the attachment member 6, a constitution in which walls are formed at edges of the fitting holes 24 on the outer sides in the scale direction and falling off of the attachment member 6 is restricted due to these walls catching the first projections 61 is described as an example. In the case of such a constitution, since both change in attachment angle of the attachment member 6 and falling off of the attachment member 6 can be restricted by the first projections 61, the second projections 62 and 63 (fitting holes 25 and 26) can also be omitted. However, if walls are formed at the edges of the fitting holes 24 on the outer sides in the scale direction, since it becomes difficult to ascertain the positions of the fitting holes 24 when the white key 2a is viewed from the side surface side, work of fitting the first projections 61 into the fitting holes 24 requires time and effort.

In contrast, in the present embodiment, the fitting holes 24 are formed along the edges of the attachment hole 21 on the opening sides (outer sides in the scale direction). That is, since the fitting holes 24 are exposed to the side surfaces of the white key 2a (protrusion portion 20), it is easy to ascertain the positions of the fitting holes 24 when the white key 2a is viewed from the side surface side. Accordingly, since the first projections 61 can be easily fitted into the fitting holes 24, workability of attachment work of the attachment member 6 can be improved.

Here, a straight line connecting the centers of the second projections 62 and 63 in the circumferential direction of the attachment member 6 to each other will be regarded as a virtual line Vc. Since the guide grooves 60 extend in a manner of intersecting (being orthogonal to) the virtual line Vc in a side view of the attachment member 6, when the attachment member 6 is compressed as described above (refer to FIG. 8A), the attachment member 6 is elastically deformed such that groove widths of the guide grooves 60 narrow. In compression of the attachment member 6 in a direction in which the groove widths of the guide grooves 60 narrow, the attachment member 6 is likely to be elastically deformed compared to when the attachment member 6 is compressed in a longitudinal direction of the guide grooves 60. Thus, workability of attachment work of the attachment member 6 can be improved.

In the present embodiment, the first projections 61 are disposed on the virtual line Vc (the second projection 62 is formed in a manner of overlapping the first projections 61). However, for example, the first projections 61 can also be formed at positions different from that of the second projection 62 in the circumferential direction of the attachment member 6. In this case, the positions of the fitting holes 24 may be changed in accordance with disposition of the first projections 61.

However, if the first projections 61 are formed at positions different from that of the second projection 62, when the attachment member 6 is elastically deformed so as to fit the second projections 62 and 63 into the fitting holes 25 and 26, change is likely to occur in the direction of the first projections 61 (a relative direction with respect to the fitting holes 24) due to distortion of the attachment member 6. Thus, when the attachment member 6 is inserted into the attachment hole 21, the first projections 61 are likely to be caught by the side surfaces of the white key 2a (protrusion portion 20) without being fitted into the fitting holes 24.

In contrast, the present embodiment has a constitution in which the first projections 61 are disposed on the virtual line Vc and the second projection 62 is formed in a manner of overlapping the first projections 61. Accordingly, when the attachment member 6 is elastically deformed so as to fit the second projections 62 and 63 into the fitting holes 25 and 26, the relative direction of the first projections 61 with respect to the fitting holes 24 is unlikely to change. Thus, when the attachment member 6 is inserted into the attachment hole 21 while being elastically deformed, since the first projections 61 are likely to be fitted into the fitting holes 24 without being caught by the side surfaces of the white key 2a (protrusion portion 20), workability of attachment work of the attachment member 6 can be improved.

In addition, the virtual line Vc is a straight line passing through the center C of the circular attachment member 6 in a side view. Namely, the second projections 62 and 63 protrude in directions opposite to each other with the center C of the attachment member 6 sandwiched therebetween. Thus, for example, in a constitution in which the first projections 61 are omitted and the second projection 62 is directly formed on the outer circumferential surface of the attachment member 6, the attachment member 6 including the second projections 62 and 63 has an external shape having rotational symmetry around the center C (axis in the scale direction). If the attachment member 6 has a shape having rotational symmetry, it is difficult for a worker to recognize which projection of the second projections 62 and 63 should be inserted into the fitting holes 25 and 26, that is, in which direction the attachment member 6 should be attached to the attachment hole 21.

In contrast, in the present embodiment, the attachment member 6 including each of the projections 61 to 63 has an external shape having no rotational symmetry around the center C (axis in the scale direction). That is, since the second projection 63 is directly formed on the outer circumferential surface of the attachment member 6 while the second projection 62 is formed in a manner of overlapping the first projections 61, it is possible to easily recognize in which direction the attachment member 6 should be attached to the attachment hole 21 by comparing the shape of the attachment member 6 (each of the projections 61 to 63) and the shape of the attachment hole 21 (each of the fitting holes 24 to 26).

In addition, the height of the second projection 62 from the outer circumferential surface of the attachment member 6 increases as much as the second projection 62 formed in a manner of overlapping the first projections 61. Thus, for example, as shown in FIG. 8B, in a state in which the attachment member 6 is inverted 180° around the center C from the state in FIG. 8A, even if the attachment member 6 is intended to be inserted into the attachment hole 21 while being elastically deformed to approximately the total protrusion dimension L1+L2 of the second projections 62 and 63 (to the extent shown in FIG. 8A), the second projection 62 is likely to be caught by the side surfaces of the white key 2a (protrusion portion 20). Thus, it is possible to curb a situation in which the attachment member 6 is inserted into the attachment hole 21 in a wrong direction.

On the other hand, for example, when the attachment member 6 is elastically deformed to approximately a dimension L1+L2+L3 which is the sum of the protrusion dimension L1+L2 of the second projections 62 and 63 and a protrusion dimension L3 of the first projections 61 (refer to FIG. 7B), that is, when the attachment member 6 is excessively elastically deformed, there is concern that the attachment member 6 may be inserted into the attachment hole 21 without having the second projection 62 caught by the side surfaces of the white key 2a (protrusion portion 20). Such excessive elastic deformation of the attachment member 6 is restricted by a partition wall 64 of the attachment member 6.

Specifically, the plate-shaped partition wall 64 protruding from the inner circumferential surfaces of the guide grooves 60 is formed in a substantially central part on the inner circumferential surfaces of the guide grooves 60 in the scale direction (arrow L-R direction). In other words, a pair of guide grooves 60 are formed on the side surfaces of the attachment member 6 on both sides in the scale direction with the partition wall 64 sandwiched therebetween, and the pair of guide grooves 60 are defined by the partition wall 64.

Since an opening 65 extending along the guide grooves 60 is formed in the partition wall 64, when the attachment member 6 is compressed such that the second projections 62 and 63 are recessed as described above (refer to FIG. 8A), elastic deformation of the attachment member 6 narrowing the groove widths of the guide grooves 60 can be tolerated.

An opening width L4 of the opening 65 in a direction along the virtual line Vc (refer to FIG. 7B) is formed to be larger than the total protrusion dimension L1+L2 of the second projections 62 and 63 (L4>L1+L2). The opening width L4 of this opening 65 allows the attachment member 6 to be attached to the attachment hole 21 in a proper posture (the state in FIG. 8A).

Meanwhile, the opening width L4 of the opening 65 is formed to be smaller than the total protrusion dimension L1+L2+L3 of the first projections 61 and the second projections 62 and 63 (L4<L1+L2+L3). Accordingly, even if the attachment member 6 is intended to be inserted into the attachment hole 21 in a state of being inverted 180° around the center C (the state in FIG. 8B), excessive elastic deformation of the attachment member 6 allowing the second projection 62 to be inserted into the fitting hole 26 can be restricted due to contact between the edges of the opening 65 (partition wall 64). Thus, it is possible to curb a situation in which the attachment member 6 is attached to the attachment hole 21 in a wrong posture.

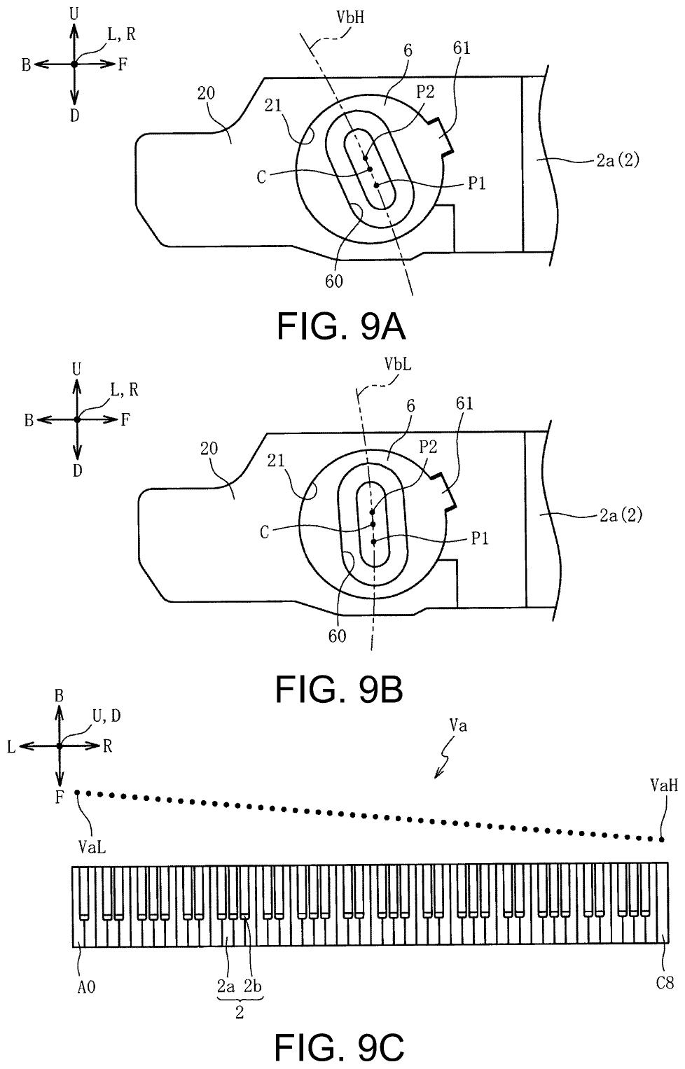

Here, as described above, the starting point P1 (refer to the enlarged part in FIG. 2) and the ending point P2 (refer to the enlarged part in FIG. 3) of the guide grooves 60 of the white key 2a are positioned on the virtual circle Vb about the virtual axis Va, but the position of the virtual axis Va is set to different positions for the key 2 on a low tone side and the key 2 on a high tone side. This constitution will be described with reference to FIGS. 9A to 9C.

FIG. 9A is a side view of the white key 2a positioned on the highest tone side, FIG. 9B is a side view of the white key 2a positioned on the lowest tone side, and FIG. 9C is a top view of the keys 2 schematically showing the positions of the virtual axes Va of the respective white keys 2a.

As shown in FIGS. 9A and 9C, for the white key 2a with a pitch name C8 positioned on the highest tone side, the starting point P1 and the ending point P2 of the guide grooves 60 are formed around a virtual circle VbH about a virtual axis VaH at a relatively close distance from the white key 2a.

Meanwhile, as shown in FIGS. 9B and 9C, for the white key 2a with a pitch name A0 positioned on the lowest tone side, the starting point P1 and the ending point P2 of the guide grooves 60 are formed around a virtual circle VbL about a virtual axis VaL at a farther distance from the white key 2a than the white key 2a with the pitch name C8.

Further, as shown in FIG. 9C, the virtual axes Va of the respective white keys 2a arranged in the scale direction are set at different positions for each of the white keys 2a. That is, since the angles of the guide grooves 60 of each of the keys 2 differ among the white keys 2a and among the black keys 2b, each of these keys 2 can swing in a different displacement trajectory without changing the dimension of each of the white keys 2a and the black keys 2b in the forward-rearward direction. Thus, unlike the structure by the technology in the related art (for example, Japanese Patent Laid-Open No. 2015-034853) in which the displacement trajectory of each key is changed by changing the overall length of each key, since lengthening the overall lengths of some of the keys 2 can be made unnecessary, it is possible to curb increase in size of the keyboard device 1.

In addition, in the present embodiment, the positions of the virtual axes Va of the respective white keys 2a arranged in the scale direction become gradually (proportionally) close to the white keys 2a from the low tone side to the high tone side of the white keys 2a. That is, the angles of the guide grooves 60 with respect to the vertical direction gradually increase from the low tone side to the high tone side of the white keys 2a. Accordingly, each of the white keys 2a can swing in a displacement trajectory close to that of an acoustic grand piano.

In this manner, it is possible to employ a constitution in which the guide grooves 60 are set at different angles among the white keys 2a and among the black keys 2b even when the guide grooves 60 are formed integrally with the white key 2a, for example. However, in a constitution in which the angles of the guide grooves 60 formed integrally with the white key 2a are changed, the mold for molding each of the white keys 2a becomes complicated, and therefore manufacturing costs of the white key 2a increase.

In contrast, the present embodiment has a structure in which the attachment member 6 having the guide grooves 60 formed on the side surfaces is attached to the white key 2a (protrusion portion 20). Accordingly, since the mold for molding the white key 2a can be simplified compared to when the angles of the guide grooves 60 formed integrally with the white key 2a are changed as described above, manufacturing costs of the white key 2a can be reduced.

In addition, since the attachment member 6 having a common external shape (each of the projections 61 to 63) is attached to each of the white keys 2a, the attachment hole 21 can also adopt a common shape in each of the white keys 2a. Accordingly, since the number of kinds of molds for molding the respective white keys 2a can be reduced, manufacturing costs of the white key 2a can be reduced.

The attachment member attached to each of the black keys 2b may have the same external shape as the attachment member 6 attached to the white key 2a or may have a different external shape. In any of the cases, it is preferable that an attachment member having a common external shape be attached to each of the black keys 2b except for the shapes (angles) of the guide grooves. Accordingly, since the attachment hole for attaching the attachment member can have a common shape in each of the black keys 2b, the number of kinds of molds for molding the respective black keys 2b can be reduced.

As described above, the attachment member 6 including the first projections 61 has an external shape having no rotational symmetry about the center C of the attachment member 6. Accordingly, it is possible to curb a situation in which the attachment member 6 is attached to the attachment hole 21 in a wrong direction (angle), and therefore the angles of the guide grooves 60 in each of the white keys 2a can be reliably set to target angles.

Here, when the virtual axis Va is set at different positions for the white key 2a on the low tone side and the white key 2a on the high tone side, there is a difference in stroke amount of the front end portion of each of the white keys 2a. This difference in stroke amount will be described with reference to FIGS. 2 and 9.

As shown in FIG. 2, in the white key 2a, swinging of a part on the front end side (arrow F side) of the guide grooves 60 is guided by rotation around the rotation axis 43 of the hammer 7 as described above. In addition, the ending edge position of this swinging is determined due to contact between the hammer 7 and a stopper 48. The stopper 48 is a cushioning material made of felt or urethane foam fixed to the chassis 4 on the upward side of the mass portion 70 of the hammer 7.

The position of the rotation axis 43 of the hammer 7 and the engagement position between the hammer 7 and the white key 2a (the lower end of the projection portion 22) are the same in each of the white keys 2a arranged in the scale direction (for example, the rotation axes 43 of the respective hammers 7 are arranged in the scale direction). Thus, when the rotation angle of the hammer 7 to the part where it comes into contact with the stopper 48 is uniform in each of the white keys 2a, the stroke amount of the white key 2a (the lower end of the projection portion 22) at the engagement position with respect to the hammer 7 is the same in each of the white keys 2a.

Meanwhile, as described above, swinging of the rear end portion of each of the white keys 2a is guided by the guide grooves 60. As shown in FIG. 9B, in the white key 2a on the low tone side, the angles of the guide grooves 60 with respect to the vertical direction are relatively small (the virtual axis Va is relatively far), and as shown in FIG. 9C, in the white key 2a on the high tone side, the angles of the guide grooves 60 with respect to the vertical direction are relatively large (the virtual axis Va is relatively close).

Thus, when the rotation angle of the hammer 7 to the part where it comes into contact with the stopper 48 shown in FIG. 2 is uniform in each of the white keys 2a, the stroke amount of the rear end portion of each of the white keys 2a (sliding amounts of the guide grooves 60 with respect to the shaft portions 41) from the initial position before key pressing to the ending edge position of key pressing becomes smaller in the white key 2a on the high tone side than in the white key 2a on the low tone side. If the stroke amount of the rear end portion of the white key 2a is relatively small, the stroke amount of the front end portion of the white key 2a (a part on a side in front of the engagement position with respect to the hammer 7) increases (the angle of the white key 2a at the ending edge position of key pressing is inclined relatively significantly with respect to the horizontal direction).

That is, when the rotation angle of the hammer 7 to the ending edge position of key pressing is uniformly set in each of the white keys 2a and the distance to the virtual axis Va is set to be closer in the white key 2a on the high tone side than on the low tone side, the stroke amount of the front end portion of the white key 2a on the high tone side becomes larger than that of the white key 2a on the low tone side. If there is a difference in stroke amount of the front end portion of each of the white keys 2a, it is not possible to give a favorable feeling of playing to a player.

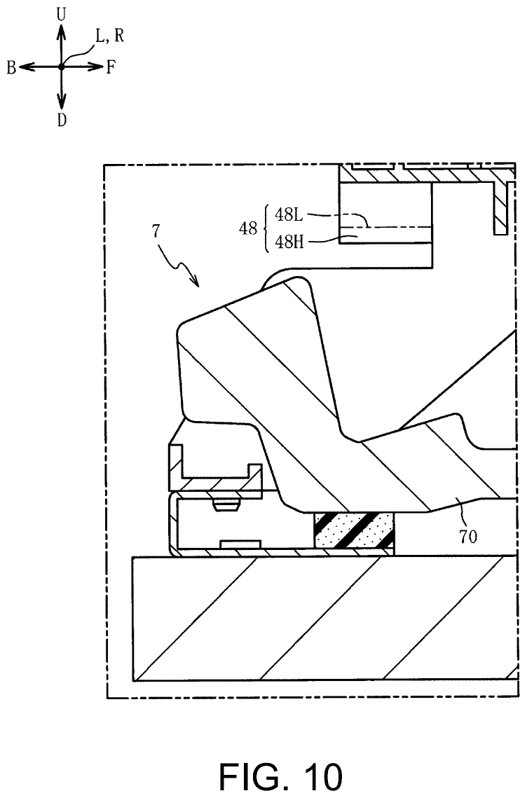

A constitution for resolving this problem will be described with reference to FIG. 10. FIG. 10 is a partial enlarged cross-sectional view of the keyboard device 1 at a position corresponding to the X part in FIG. 2. FIG. 10 illustrates a cross section including a stopper 48H positioned on the highest tone side (corresponding to the white key 2a with the pitch name C8). However, in order to simplify the drawings, hatching of the stopper 48H is omitted.

As shown in FIG. 10, in the stoppers 48, a stopper positioned on the lowest tone side (corresponding to the white key 2a with the pitch name A0) will be regarded as a stopper 48L, and a stopper positioned on the highest tone side (corresponding to the white key 2a with the pitch name C8) will be regarded as the stopper 48H. The thickness of the stopper 48H is formed to be larger than the thickness of the stopper 48L. Further, although illustration is omitted, the stoppers 48 are formed to have a thickness gradually (proportionally) increasing from the stopper 48L of the white key 2a on the lowest tone side to the stopper 48H of the white key 2a on the highest tone side.

Namely, the spacing between the mass portion 70 (a part which comes into contact with the stopper 48 when the white key 2a is pressed) of the hammer 7 in the rotation direction and the stopper 48 gradually narrows from the white key 2a on the low tone side to the white key 2a on the high tone side. Accordingly, the rotation angle of the hammer 7 to the part where it comes into contact with the stopper 48 when the white key 2a is pressed can be made smaller in the white key 2a on the high tone side than in the white key 2a on the low tone side. Thus, as described above, even when the distance to the virtual axis Va is set to be closer in the white key 2a on the high tone side than in the white key 2a on the low tone side, the stroke amount of the front end portion of each of the white keys 2a can be made uniform. Thus, it is possible to give a favorable feeling of playing to a player.

In the present embodiment, the stroke amount of the front end portion of each of the white keys 2a is made uniform by changing the thickness of the stopper 48, but the embodiment is not necessarily limited to this. For example, a constitution in which the thickness of the mass portion 70 of the hammer 7 in the upward-downward direction gradually (proportionally) increases from the low tone side to the high tone side while the stopper 48 of each of the white keys 2a has the same thickness in each of the white keys 2a may be adopted. In this constitution as well, the spacing between the mass portion 70 of the hammer 7 in the rotation direction and the stopper 48 can be formed to gradually narrow from the white key 2a on the low tone side to the white key 2a on the high tone side.

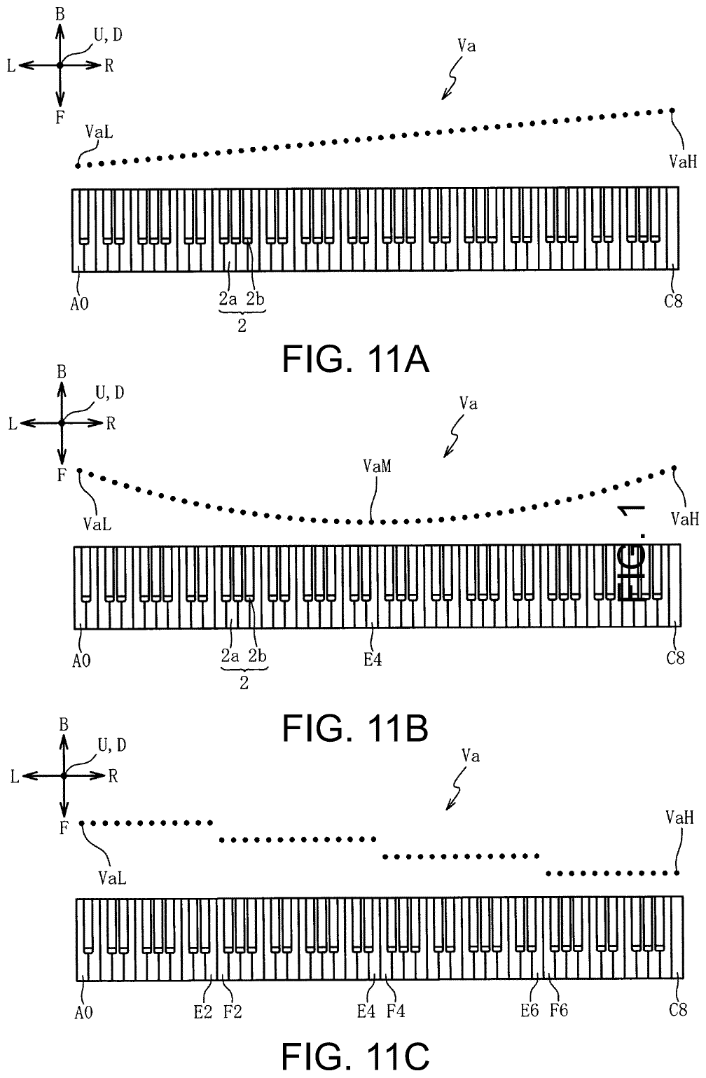

Next, with reference to FIG. 11, a modification example of disposition of the virtual axes Va will be described. FIG. 11A is a top view of the keys 2 schematically showing the positions of the virtual axes Va according to the first modification example, FIG. 11B is a top view of the keys 2 schematically showing the positions of the virtual axes Va according to the second modification example, and FIG. 11C is a top view of the keys 2 schematically showing the positions of the virtual axes Va according to the third modification example.

As shown in FIG. 11A, in the first modification example of the virtual axes Va, the virtual axis VaH of the white key 2a on the highest tone side (pitch name C8) is set at a position farther from the white key 2a than the virtual axis VaL of the white key 2a on the lowest tone side (pitch name A0). Further, the virtual axes Va are provided to become gradually (proportionally) distant from the white keys 2a from the low tone side to the high tone side of the white keys 2a. Accordingly, the displacement trajectories of the white keys 2a can be gradually changed from the white key 2a on the low tone side to the white key 2a on the high tone side. Such a distance from the white key 2a to the virtual axis Va can be adjusted by changing the angles of the guide grooves 60 (refer to FIGS. 9A to 9C) as described above. The same also applies to other modification examples below.

As shown in FIG. 11B, in the second modification example of the virtual axes Va, the distance from the white key 2a is the same in the virtual axis VaL of the white key 2a on the lowest tone side and the virtual axis VaH of the white key 2a on the highest tone side. Meanwhile, a virtual axis VaM of the white key 2a in a middle register (for example, the pitch name E4) is set at a position closer to the white key 2a than the virtual axes VaL and VaH. Further, the virtual axes Va are provided to become gradually (quadratically) close to the white keys 2a from the white keys 2a on the low tone side and the high tone side to the white key 2a in the middle register. Accordingly, the displacement trajectories of the white keys 2a can be gradually changed from the white keys 2a on the low tone side and the high tone side to the white key 2a in the middle register.

As shown in FIG. 11C, in the third modification example of the virtual axes Va, the virtual axes Va are provided to become gradually (in stages) close to the white keys 2a from the virtual axis VaL of the white key 2a on the lowest tone side to the virtual axis VaH of the white key 2a on the highest tone side.

More specifically, the registers of the white keys 2a are divided (equally divided) into four registers. Compared to the white keys 2a in the registers on the lowest tone side (for example, the pitch names A0 to E2), in the white keys 2a on the middle register side (for example, the pitch names F2 to E4) therefrom, the virtual axis Va is set at a closer position. Meanwhile, the white keys 2a forming the same division region (for example, the pitch names A0 to E2) have the same distance to the virtual axis Va.

Similar to this, compared to the white keys 2a in the middle register on a relatively high tone side (for example, the pitch names F4 to E6), in the white keys 2a in the register on the highest tone side (for example, the pitch names F6 to C8), the virtual axis Va is set at a closer position. However, the white keys 2a forming the same division region (for example, the pitch names F4 to E6) have the same distance to the virtual axis Va.

In this manner, by setting the virtual axis Va to be gradually close from the low tone side to the high tone side of the white keys 2a, similar to the foregoing embodiment (refer to FIG. 9C), each of the white keys 2a can swing in a displacement trajectory close to that of an acoustic grand piano. Moreover, since the positions of the virtual axes Va are close to the white keys 2a in stages from the low tone side to the high tone side, the angles of the guide grooves 60 with respect to the vertical direction can also be similarly increased in stages from the low tone side to the high tone side of the white keys 2a. Accordingly, since the same angles of the guide grooves 60 may be set to the white keys 2a having the same position of the virtual axis Va (for example, the pitch names A0 to E2), the common attachment member 6 can be attached to each of the white keys 2a. Accordingly, since the number of kinds of the attachment member 6 to be used can be reduced, manufacturing costs of the attachment member 6 can be reduced.

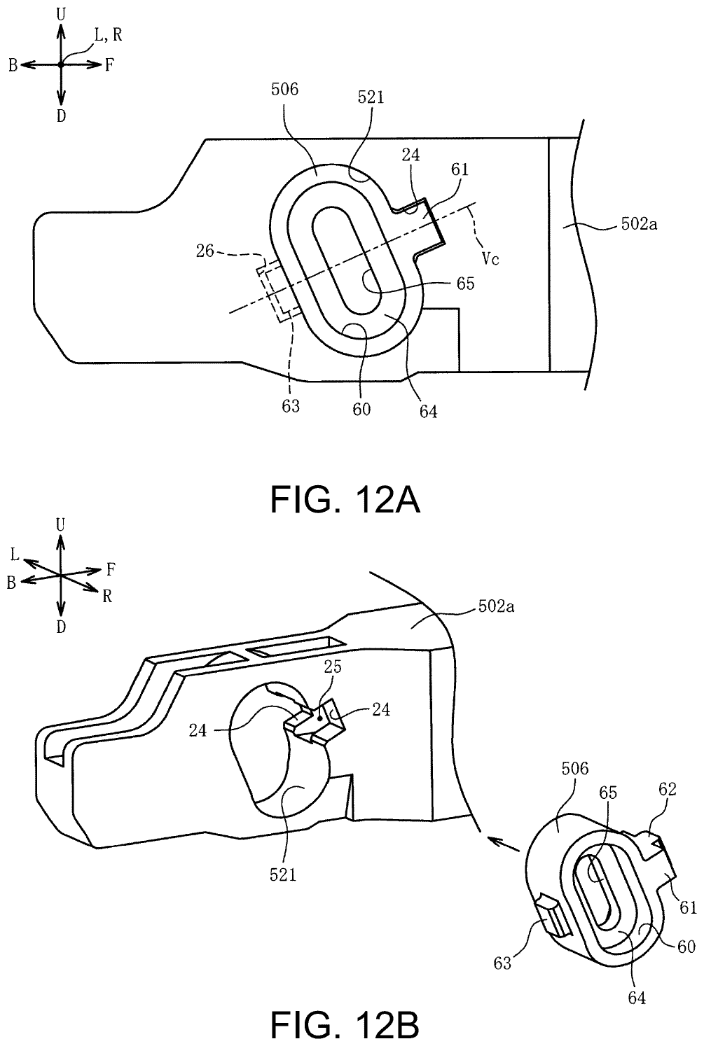

Next, with reference to FIG. 12, a white key 502a of a fourth modification example will be described. The same reference signs are applied to parts which are the same as those in the foregoing embodiment, and description thereof will be omitted. FIG. 12A is a side view of the white key 502a of the fourth modification example, and FIG. 12B is a perspective view of the white key 502a showing a state in which an attachment member 506 is detached from an attachment hole 521.

As shown in FIG. 12, the white key 502a of the fourth modification example has the same constitution as the white key 2a described in the foregoing embodiment (refer to FIGS. 9A to 9C) except that the inner circumferential surface of the attachment hole 521 has an oval shape. That is, the fitting holes 24 to 26 similar to that of the white key 2a are formed in the attachment hole 521 of the white key 502a.

The attachment member 506 attached to the attachment hole 521 has the same constitution as the attachment member 6 described in the foregoing embodiment except that it has an oval external shape (a shape corresponding to the attachment hole 521) along the shapes of the guide grooves 60. That is, the first projections 61, the second projections 62 and 63, and the partition wall 64 (opening 65) are formed in the attachment member 506.

Since the attachment member 506 is formed using a soft material having a lower hardness than a resin which is a material of the white key 502a, it is possible to curb occurrence of noise at the time of sliding in the guide grooves 60 along the shaft portions 41 (refer to FIG. 3).

Here, in the foregoing embodiment, cases in which the angles of the guide grooves 60 are set to different angles for each of the white keys 2a (or each of the black keys 2b) have been described. However, in the modification example shown in FIG. 12, the angles of the guide grooves 60 are set to the same angle for all the white keys 502a arranged in the scale direction. Namely, the attachment hole 521 having a common shape is formed in each of the white keys 502a, and the common attachment member 506 is attached to the attachment hole 521 thereof.

Further, when a straight line connecting the centers of the second projections 62 and 63 to each other in a direction around the outer circumferential surface of the attachment member 506 is the virtual line Vc, the attachment member 506 has a line-symmetrical external shape having the virtual line Vc as an axis of symmetry in a side view. In addition, the guide grooves 60 also have a line-symmetrical shape having the virtual line Vc as an axis of symmetry in a side view. Namely, the attachment member 506 has a shape of rotational symmetry (two-fold symmetry) about the virtual line Vc and can be attached to the attachment hole 521 even if the front and the rear of the attachment member 506 are inverted 180° around the virtual line Vc. Accordingly, the attachment member 506 can be attached without considering the front and the rear around the virtual line Vc with respect to all the white keys 502a arranged in the scale direction. Thus, workability of attachment work of the attachment member 506 can be improved.

Such a shape of rotational symmetry (two-fold symmetry) having the virtual line Vc as an axis of symmetry may be applied to each of the attachment members 6 of the foregoing embodiment (refer to FIGS. 9A and 9B). In this case, the shape of the attachment hole 21 (the position of each of the fitting holes 24 to 26), that is, the angles of the guide grooves 60 (the positions of the virtual axes Va) can also be similarly changed by gradually changing the attachment angle of the attachment member 6 from the low tone side to the high tone side of the white keys 2a.

Next, with reference to FIG. 13, the white key 602a of the fifth modification example will be described. FIG. 13A is a perspective view of the white key 602a of the fifth modification example, and FIG. 13B is a perspective view of the white key 602a showing a state in which the attachment member 606 is detached from the protrusion portion 620.

As shown in FIG. 13, the protrusion portion 620 of the white key 602a of the fifth modification example is formed to have a plate shape (rectangular parallelepiped shape) extending in the forward-rearward direction (arrow F-B direction), and the attachment member 606 is attached to this protrusion portion 620. The attachment member 606 is formed to have an angular tube shape having an insertion hole 666 extending in the forward-rearward direction, and the guide grooves 60 penetrate the side surfaces of the attachment member 606 in the scale direction (arrow L-R direction).

The dimensions of the protrusion portion 620 in each of the upward-downward direction and the scale direction are formed to be the same as (or slightly smaller than) the dimensions of the insertion hole 666 in the same directions, and the attachment member 606 is attached to the white key 602a when the protrusion portion 620 is inserted into the insertion hole 666 of the attachment member 606. Accordingly, since formation of a hole for attaching the attachment member 606 in the protrusion portion 620 can be made unnecessary, the rigidity of the protrusion portion 620 can be ensured.

Since the attachment member 606 is formed using a soft material having a lower hardness than a resin which is a material of the white key 602a, it is possible to curb occurrence of noise at the time of sliding in the guide grooves 60 along the shaft portions 41 (refer to FIG. 3).

A first restriction portion 627 and the second restriction portions 628 for restricting displacement of the attachment member 606 to the front and the rear mounted in the protrusion portion 620 are formed in the white key 602a. The first restriction portion 627 is a part of which the dimensions in the scale direction and the upward-downward direction are formed to be larger than those of the protrusion portion 620. Since the protrusion portion 620 protrudes to the rear side from the rear surface of this first restriction portion 627, displacement of the attachment member 606 to the front side is restricted by the first restriction portion 627 in a state in which the attachment member 606 is mounted in the protrusion portion 620.

Meanwhile, the second restriction portions 628 are formed on the rear end side of the protrusion portion 620. The second restriction portions 628 are vertically extending projections and protrude from the side surfaces of the protrusion portion 620 on both sides in the scale direction. The rear surfaces of the second restriction portions 628 are inclined surfaces inclined to the front side as they go toward the outer side in the scale direction. Thus, when the protrusion portion 620 is inserted into the insertion hole 666 of the attachment member 606, the attachment member 606 surmounts the second restriction portions 628 while the attachment member 606 (insertion hole 666) opens wide along the inclined rear surfaces of the second restriction portions 628, and therefore the attachment member 606 is attached to the protrusion portion 620.

The dimension from the rear surface of the first restriction portion 627 to the second restriction portions 628 is substantially the same as that of the attachment member 606 in the forward-rearward direction, and the attachment member 606 is sandwiched between the restriction portions 627 and 628, and therefore displacement of the attachment member 606 to the front and the rear is restricted. Accordingly, while making it unnecessary to adhere the attachment member 606 to the white key 602a, it is possible to curb a situation in which the attachment member 606 falls off from the protrusion portion 620.

Hereinabove, description has been given based on the foregoing embodiment. However, the disclosure is not limited by the foregoing embodiment in any way, and it can be easily inferred that various improvements and modifications can be made within a range not departing from the gist of the disclosure.

In the foregoing embodiment, cases in which the attachment member 6, 506, or 606 having the guide grooves 60 is attached to the white key 2a, 202a, 302a, 402a, 502a, or 602a have been described, but the embodiment is not necessarily limited to these. For example, the guide grooves 60 may be formed integrally with the white key 2a, 202a, 302a, 402a, 502a, or 602a.

In the foregoing embodiment, cases in which the guide grooves 60 of the attachment member 6, 506, or 606 attached to the white key 2a, 202a, 302a, 402a, 502a, or 602a are slidably engaged with the shaft portions 41 of the chassis 4 have been described, but the embodiment is not necessarily limited to these. For example, the guide grooves 60 may be formed in the chassis 4, and a guide shaft which can slide in the guide grooves 60 may be formed in the white key 2a, 202a, 302a, 402a, 502a, or 602a. In the case of such a constitution, an attachment hole capable of attaching a member corresponding to the attachment member 6, 506, or 606 may be formed on the chassis 4 (wall portions 40) side, and the guide grooves 60 may be directly formed in the wall portions 40.

In the foregoing embodiment, cases in which gaps are respectively formed between the inclined surfaces 20cl or 420h1 and the curved surfaces 20c2 or 420h2 of the guided surfaces 20c or 420h and the guide surfaces 46c or 447a have been described, but the embodiment is not necessarily limited to these. For example, the entire inclined surfaces 20cl or 420h1 (or parts thereof on the upper end sides) may be formed parallel to the guide surfaces 46c or 447a and brought into surface contact therewith, and gaps may be formed only between the curved surfaces 20c2 or 420h2 and the guide surfaces 46c or 447a. In addition, the curved surfaces 20c2 or 420h2 may be omitted, and the guided surfaces 20c or 420h may be formed from only the inclined surfaces 20cl or 420h1. That is, if gaps are formed between the guided surfaces 20c or 420h and the guide surfaces 46c or 447a in a region including at least the lower ends of the guided surfaces 20c or 420h, it is possible to curb a situation in which the grease is scraped off.

In the foregoing embodiment, cases in which the attachment member 6, 506, or 606 (guide grooves 60) is formed using a material having a lower hardness than that of the white key 2a have been described, but the embodiment is not necessarily limited to these. For example, the shaft portions 41 of the chassis 4 (guide shaft) may be formed using a material having a lower hardness than that of the white key 2a. In this case, the attachment member 6, 506, or 606 (guide grooves 60) may also be similarly formed using a material having a lower hardness than that of the white key 2a, and the hardness of the attachment member 6, 506, or 606 (guide grooves 60) may be the same as that (or higher than that) of the white key 2a. In addition, the attachment member 6, 506, or 606 (guide grooves 60) and the shaft portions 41 (guide shaft) may have the same hardness, or either one may have a higher hardness than the other.

In the foregoing embodiment, cases in which the attachment member 6 or 506 has a circular or oval external shape have been described. However, the external shape of the attachment member 6 or 506 may be a polygonal shape or may be a combined shape of a circular shape and a polygonal shape. That is, as long as the guide grooves 60 are included, the shape of the attachment member 6 or 506 can be suitably set.

In the foregoing embodiment, cases in which the attachment member 6 or 506 is attached to the attachment hole 21 or 521 respectively through fitting between the projections 61 to 63 of the attachment member 6 or 506 and the fitting holes 24 to 26 of the attachment hole 21 or 521 have been described, but the embodiment is not necessarily limited to these. For example, any one of or all the projections 61 to 63 (fitting holes 24 to 26) may be omitted, and the attachment member 6 or 506 may be adhered to the attachment hole 21 or 521. In addition, projecting portions corresponding to the respective projections 61 to 63 may be provided on the attachment hole 21 or 521 side. Meanwhile, recessed portions corresponding to the fitting holes 24 to 26 may be provided in the attachment member 6 or 506.

In the foregoing embodiment, cases in which change in attachment angle of the attachment member 6 with respect to the attachment hole 21 is restricted through fitting between the fitting holes 24 and the first projections 61 have been described, but the embodiment is not necessarily limited to these. For example, the fitting holes 24 and the first projections 61 may be omitted, and change in attachment angle of the attachment member 6 may be restricted through fitting between any one of or both the second projections 62 and 63 and the fitting holes 25 and 26. In this case, the dimensions of the fitting holes 25 and 26 in the circumferential direction of the attachment hole 21 may be formed to be the same as (or slightly larger than) the dimensions of the second projections 62 and 63 in the same direction.

In the foregoing embodiment, cases in which the virtual line Ve connecting the second projections 62 and 63 (first projections 61) to each other and the guide grooves 60 intersect in a side view and cases in which the first projections 61 are formed on the virtual line Ve have been described, but the embodiment is not necessarily limited to these. For example, a constitution in which the virtual line Vc and the guide grooves 60 do not intersect may be adopted, and the first projections 61 may be formed at a position not overlapping the virtual line Vc. That is, a formation position of each of the projections 61 to 63 on the outer circumferential surface of the attachment member 6 or 506 can be suitably set.

In the foregoing embodiment, cases in which the fitting holes 24 are formed along the edges of the attachment hole 21 on the opening sides (outer sides in the scale direction) have been described, but the embodiment is not necessarily limited to these. For example, walls may be formed at the edges of the fitting holes 24 on the outer sides in the scale direction, and falling off of the attachment member 6 may be restricted due to these walls catching the first projections 61. In this case, the second projections 62 and 63 (fitting holes 25 and 26) may be omitted.

In the foregoing embodiment, cases in which the guide grooves 60 are formed in a linear shape from the starting point P1 to the ending point P2 have been described. However, the guide grooves 60 may be formed in an arc shape from the starting point P1 to the ending point P2.

In the foregoing embodiment, cases in which the outer circumferential surfaces of the shaft portions 41 comes into contact with only the sliding surfaces of the guide grooves 60 at each of the initial position before key pressing and the ending edge position of key pressing have been described, but the embodiment is not necessarily limited to these. For example, the outer circumferential surfaces of the shaft portions 41 may come into contact with the inner circumferential surfaces of the guide grooves 60 on the lower end side or the upper end side at any one of or both the initial position before key pressing or the ending edge position of key pressing.

In the foregoing embodiment, cases in which the opening 65 is formed in the partition wall 64 defining the guide grooves 60 have been described. However, the partition wall 64 or the opening 65 may be omitted. In addition, cases in which the opening width L4 of the opening 65 is formed to be smaller than the total protrusion dimension L1+L2+L3 of the first projections 61 and the second projections 62 and 63 have been described. However, the opening width L4 of the opening 65 may be formed to be the same as that (or smaller than that) of the total protrusion dimension L1+L2+L3 of the first projections 61 and the second projections 62 and 63 (need only be larger than at least the protrusion dimension L1+L2 of the second projections 62 and 63).

In the foregoing embodiment, cases in which the attachment member 506 has a line-symmetrical external shape (shapes of the guide grooves 60) having the virtual line Vc as an axis of symmetry in a side view have been described. However, the attachment member 506 may have an asymmetrical external shape (shapes of the guide grooves 60) about the virtual line Vc.

In the foregoing embodiment, cases in which the spacing between the mass portion 70 (a part which comes into contact with the stopper 48 when the white key 2a is pressed) of the hammer 7 in the rotation direction and the stopper 48 gradually narrows from the white key 2a on the low tone side to the white key 2a on the high tone side have been described, but the embodiment is not necessarily limited to these. For example, the spacing between the mass portion 70 of the hammer 7 in the rotation direction and the stopper 48 may be uniform from the white key 2a on the low tone side to the white key 2a on the high tone side.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A keyboard device comprising:
a support member; and
keys which are swingably supported by the support member,
wherein one of the support member and the key comprises a guide groove which guides swinging of a rear portion of the key,
an other of the support member and the key comprises a guide shaft which extends in a scale direction, is inserted into the guide groove, and slides along the guide groove when the key swings,
the keys comprise white keys and black keys, and
when a point where a center of the guide shaft is positioned in a state before the key is pressed is a starting point of the guide groove, a point where the center of the guide shaft is positioned in a state in which the key is pressed to an ending edge position is an ending point of the guide groove, and a straight line connecting the starting point and the ending point is an angle of the guide groove, the angle of the guide groove differs between the white keys or between the black keys.

2. The keyboard device according to claim 1 further comprising:
an attachment member in which the guide groove is formed and which is attached to the support member or the key.

3. The keyboard device according to claim 2,
wherein the support member or the key comprises an attachment hole which is provided to allow the attachment member to be inserted thereinto in the scale direction and to which the attachment member is attached, and
an external shape of the attachment member along an inner circumferential surface of the attachment hole is common between the white keys or between the black keys.

4. The keyboard device according to claim 3,
wherein the external shape of the attachment member is a shape having no rotational symmetry around an axis in the scale direction.

5. The keyboard device according to claim 3,
wherein the attachment member is formed by using a softer material than the key.

6. The keyboard device according to claim 1,
wherein the angle of the guide groove with respect to a vertical direction gradually increases from a low tone side to a high tone side of the keys.

7. The keyboard device according to claim 6 further comprising:
a hammer which engages with the key on a side in front of a swinging fulcrum of the key and rotates around a predetermined rotation axis; and
a stopper which comes into contact with the hammer at the ending edge position and restricts rotation of the hammer,
wherein a spacing between the hammer and the stopper gradually narrows from the low tone side to the high tone side of the keys.

8. The keyboard device according to claim 6 further comprising:
an attachment member in which the guide groove is formed and which is attached to the support member or the key,
wherein the angle of the guide groove with respect to the vertical direction increases in stages from the low tone side to the high tone side of the keys.

9. A keyboard device comprising:
a support member; and
keys which are swingably supported by the support member,
wherein one of the support member and the key comprises a guide groove which guides swinging of a rear portion of the key,
an other of the support member and the key comprises a guide shaft which extends in an arrangement direction of the keys, is inserted into the guide groove,
the keys comprise white keys and black keys, and
when a point where a center of the guide shaft is positioned in a state before the key is pressed is a starting point of the guide groove, a point where the center of the guide shaft is positioned in a state in which the key is pressed to an ending edge position is an ending point of the guide groove, and a straight line connecting the starting point and the ending point is an angle of the guide groove, the angle of the guide groove differs between the white keys or between the black keys.

10. The keyboard device according to claim 9 further comprising:
an attachment member in which the guide groove is formed and which is attached to the support member or the key.

11. The keyboard device according to claim 10,
wherein the support member or the key comprises an attachment hole which is provided to allow the attachment member to be inserted thereinto in the arrangement direction and to which the attachment member is attached, and
an external shape of the attachment member along an inner circumferential surface of the attachment hole is common between the white keys or between the black keys.

12. The keyboard device according to claim 11,
wherein the external shape of the attachment member is a shape having no rotational symmetry around an axis in the arrangement direction.

13. The keyboard device according to claim 11,
wherein the attachment member is formed by using a softer material than the key.

14. The keyboard device according to claim 9,
wherein the angle of the guide groove with respect to a vertical direction gradually increases from a low tone side to a high tone side of the keys.

15. The keyboard device according to claim 14 further comprising:
a hammer which engages with the key on a side in front of a swinging fulcrum of the key and rotates around a predetermined rotation axis; and
a stopper which comes into contact with the hammer at the ending edge position and restricts rotation of the hammer,
wherein a spacing between the hammer and the stopper gradually narrows from the low tone side to the high tone side of the keys.

16. The keyboard device according to claim 14 further comprising:
an attachment member in which the guide groove is formed and which is attached to the support member or the key,
wherein the angle of the guide groove with respect to the vertical direction increases in stages from the low tone side to the high tone side of the keys.

17. A method for guiding a key in a keyboard device comprising a support member, and keys which are swingably supported by the support member,
wherein one of the support member and the key comprises a guide groove which guides swinging of a rear portion of the key,
the other of the support member and the key comprises a guide shaft which extends in a scale direction and is inserted into the guide groove,
the keys comprise white keys and black keys,
when a point where a center of the guide shaft is positioned in a state before the key is pressed is a starting point of the guide groove, a point where the center of the guide shaft is positioned in a state in which the key is pressed to an ending edge position is an ending point of the guide groove, and a straight line connecting the starting point and the ending point is an angle of the guide groove, the angle of the guide groove differs between the white keys or between the black keys, the method comprising:
guiding swinging when the key is pressed through sliding between the guide groove and the guide shaft.

18. The method according to claim 17 further comprising:
providing an attachment member in which the guide groove is formed and which is attached to the support member or the key.

19. The method according to claim 18,
wherein the support member or the key comprises an attachment hole which is provided to allow the attachment member to be inserted thereinto in the scale direction and to which the attachment member is attached, and
an external shape of the attachment member along an inner circumferential surface of the attachment hole is common between the white keys or between the black keys.

20. The method according to claim 19,
wherein the external shape of the attachment member is a shape having no rotational symmetry around an axis in the scale direction.
